(19) United States
(12) Patent Application Publication
(10) Pub. No.: US 2021/0217245 A1
(43) Pub. Date: Jul. 15, 2021

(54) System and Method of Competitively Gaming in a Mixed Reality with Multiple Players

(71) Applicant: Kurt Akman, Land O Lakes, FL (US)

(72) Inventor: Kurt Akman, Land O Lakes, FL (US)

(21) Appl. No.: 17/149,716

(22) Filed: Jan. 14, 2021

Related U.S. Application Data
(60) Provisional application No. 62/961,015, filed on Jan. 14, 2020.

(51) Int. Cl. G06T 19/00; A63F 13/212; A63F 13/285; A63F 13/79; A63F 9/24

(52) U.S. Cl. CPC G06T 19/006; A63F 13/212; A63F 13/285; A63F 2009/246; A63F 9/24; A63F 2009/2494; A63F 2009/2488; A63F 13/79

(57) ABSTRACT

A system and method of competitively gaming in a mixed reality with multiple players provides a facility in which various types of drone/RC vehicle, including, but not limited to, quadcopters, submarines, tanks, radio-controlled vehicles, and more, may be stored, maintained, and deployed. Appropriate environments are provided and changed in order to provide variety to the gamers. Users enter a pod equipped with virtual reality headgear and several controls befitting the drone/RC vehicle type or game type being played. The virtual reality headgear enables users to control the drone/RC vehicle from a first-person perspective, utilizing cameras strategically dispersed throughout the drone/RC vehicle. Between uses, drones/RC vehicles are sent through automated maintenance, which allows for standard maintenance for functional units and automated part replacement as needed for damaged units. The automated maintenance allows for continuous play, as opposed to single unit aerial drone racing, in which drones generally require maintenance between uses.

The current application claims a priority to the U.S. Provisional Patent application Ser. No. 62/961,015 filed on Jan. 14, 2020.

### FIELD OF THE INVENTION

The present invention generally relates to gaming systems. More specifically, the system and method of competitively gaming in a mixed reality with multiple players relates to a method for enabling cooperative and competitive drone/radio controlled (RC) vehicle control. Normally complex controls are made accessible to casual fans, and an audience can watch physical drones/RC vehicles interact in real time according to player inputs.

### BACKGROUND OF THE INVENTION

With the growth in industries such as virtual reality gaming, eSports and aerial drone racing, there is a growing need for the next generation of interactive game play. The eSports industry has grown massively, with users and audiences that want more than ever to experience live competitive events, where the users may compete against each other within video games or hardware competitions such as aerial drone racing.

Unfortunately, each of these categories presents its own set of problems and limitations with respect to recruitment of new users. A problem with eSports is that eSports are fully virtual and lack the true spectacle of a game like aerial drone racing. Further, eSports equipment can be expensive for an enthusiast to purchase, install, and maintain. On the other hand, aerial drone racing is generally perceived to be inaccessible due to the requirement for users to have a fairly complicated understanding of aeronautics. The barrier to entry for aerial drone racing is further heightened due to potential requirements for special licensing, depending on local laws. Furthermore, aerial drone racing uses a traditional handheld controller or mobile device to control the movement of the aerial drone, which mitigates the immersive ecosystem sought by the described invention. What is needed is an accessible combination of virtual reality gaming, eSports, and aerial drone racing. Further desirable is a method by which physical drones or remotely-controlled units may be automatically maintained.

The present invention addresses these issues. The system and method of competitively gaming in a mixed reality with multiple players generally provides a facility in which various types of drone/radio-controlled (RC) vehicle, including, but not limited to, quadcopters, submarines, tanks, RC cars or trucks, and more, may be stored, maintained, and deployed. Appropriate environments are provided and changed in order to provide variety to the gamers. Users enter a pod equipped with virtual reality headgear and several controls befitting the drone type or game type being played. The virtual reality headgear enables users to control the drone/RC vehicle from a first-person perspective, utilizing cameras strategically dispersed throughout the drone. Haptic feedback further increases user immersion in gaming events. Between uses, drones/RC vehicles are sent through automated maintenance, which allows for cooling, charging, and other standard maintenance for otherwise functional units and automated part replacement as needed for damaged units. The automated maintenance, coupled with high drone/RC vehicle inventory, allows for continuous play, as opposed to single unit aerial drone racing, in which drones generally require maintenance between uses.

### BRIEF DESCRIPTION OF THE DRAWINGS

FIG. 1 is a block diagram illustrating the system of the present invention.

FIG. 2 is a flowchart illustrating the overall process of the present invention.

FIG. 3 is a continuation of FIG. 2.

FIG. 4 is a flowchart illustrating a subprocess of capturing video data.

FIG. 5 is a flowchart illustrating a subprocess of augmenting video data.

FIG. 6 is a flowchart illustrating a subprocess of capturing audio data.

FIG. 7 is a flowchart illustrating a subprocess of augmenting audio data.

FIG. 8 is a flowchart illustrating a subprocess of capturing haptic data.

FIG. 9 is a flowchart illustrating a subprocess of augmenting haptic data.

FIG. 10 is a flowchart illustrating a subprocess of communicating controls to an avatar.

FIG. 11 is a flowchart illustrating a subprocess of managing avatar maintenance.

FIG. 12 is a continuation of FIG. 11.

FIG. 13 is a flowchart illustrating a subprocess of automatically moving avatars to the computerized maintenance center.

FIG. 14 is a flowchart illustrating a subprocess of creating a backup avatar queue.

FIG. 15 is a flowchart illustrating a subprocess of performing standard maintenance.

FIG. 16 is a flowchart illustrating a subprocess of managing severely damaged avatars.

FIG. 17 is a flowchart illustrating a subprocess of remotely connecting to the central computing device.

FIG. 18 is a flowchart illustrating a subprocess of providing artificial intelligence players.

FIG. 19 is an illustration of an online platform consistent with various embodiments of the present disclosure.

FIG. 20 is a block diagram of a system to facilitate mixed reality competitive gameplay, in accordance with some embodiments.

FIG. 21 is a schematic of a conveyor system process, in accordance with some embodiments.

FIG. 22 is a side view of a driver in a driver cockpit associated with the mixed reality competitive gameplay, in accordance with some embodiments.

FIG. 23 is an exemplary illustration of the mixed reality competitive gameplay, in accordance with some embodiments.

FIG. 24 is a top view of a conveyor staging, in accordance with some embodiments.

FIG. 25 is a side view of an RC controller containment unit, in accordance with some embodiments.

FIG. 26 is an illustration of a battle royal gameplay type, in accordance with some embodiments.

FIG. 27 is an illustration of a racing gameplay type, in accordance with some embodiments.

FIG. 28 is an illustration of a submersible gameplay type, in accordance with some embodiments.

FIG. 29 is a block diagram of a computing device for implementing the methods disclosed herein, in accordance with some embodiments.

### DETAILED DESCRIPTION OF THE INVENTION

All illustrations of the drawings are for the purpose of describing selected versions of the present invention and are not intended to limit the scope of the present invention.

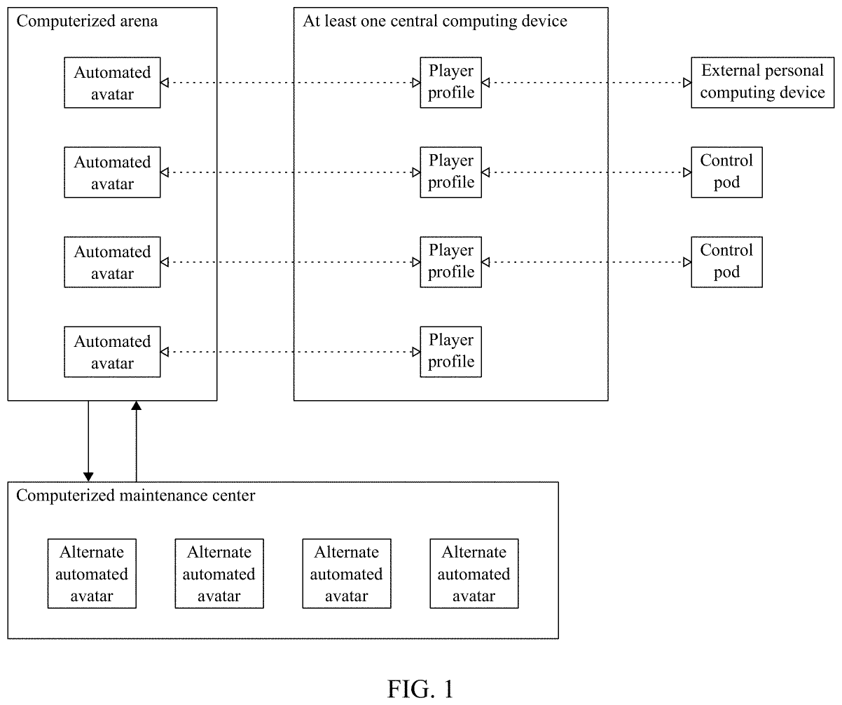

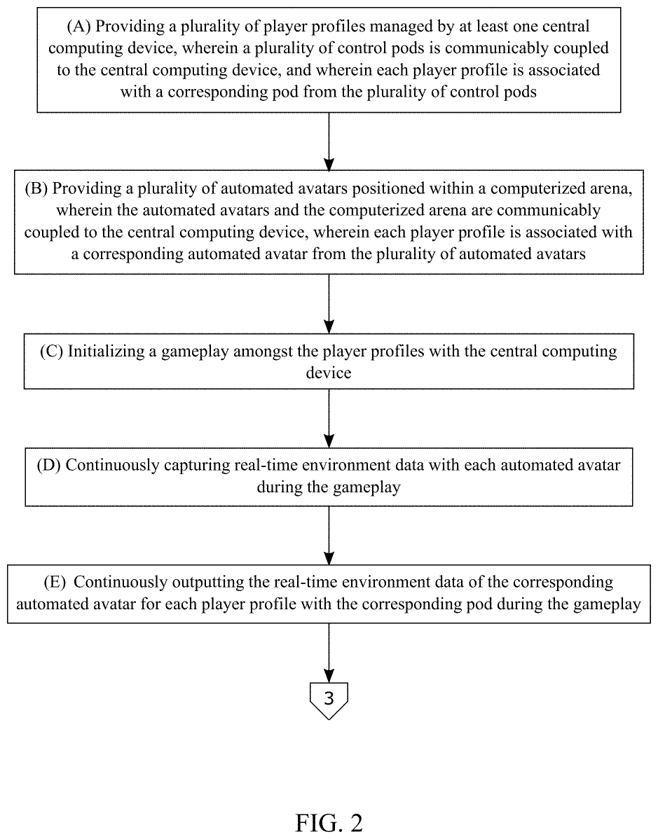

The present invention is a system and method of competitively gaming in a mixed reality with multiple players that provides a system that allows casual enthusiasts to use virtual reality (VR) equipment to engage in drone/radio-controlled (RC) vehicle games, such as races, battle royals, map exploration, and more, as represented in FIG. 1. The present invention accomplishes this by providing a control pod equipped with appropriate controls, as well as a facility for the storage, maintenance, and deployment of automated avatars. The system of the present invention includes a plurality of player profiles managed by at least one central computing device, wherein a plurality of control pods is communicably coupled to the central computing device, and wherein each player profile is associated with a corresponding pod from the plurality of control pods (Step A), as represented in FIG. 2. The plurality of player profiles relates to a set of players associated with each active control pod of the plurality of control pods. This information enables the present invention to establish gaming lobbies or groups of players. The at least one central computing device is a processor or group of processors and necessary hardware required to store user information, collect and analyze data, and transmit necessary data to the plurality of control pods in real time. The plurality of control pods is the set of preferably contained units which house the various controls and equipment necessary for immersive gameplay. The present invention further provides a plurality of automated avatars positioned within a computerized arena, wherein the automated avatars and the computerized arena are communicably coupled to the central computing device, and wherein each of the player profiles is associated with a corresponding automated avatar from the plurality of automated avatars (Step B). The plurality of automated avatars relates to a series of RC vehicles, including, but not limited to, quadcopters, aerial drones, submarines, sea vessels, tanks, land units, and more that are equipped with cameras, sensors, and other electronic components necessary to provide an immersive gaming environment for users. The computerized arena relates to a controlled environment in which the plurality of automated avatars may move and, in a preferred embodiment, be viewed by an audience or telecommunications tools.

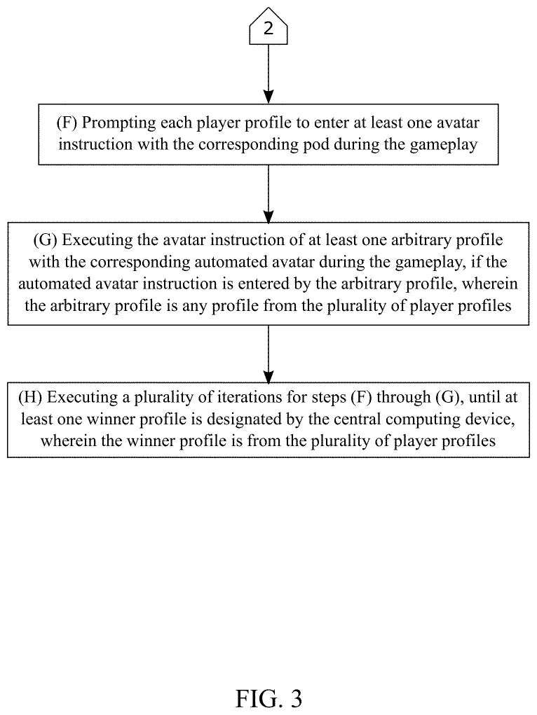

The overall process followed by the method of the present invention allows for effective and efficient deployment of automated avatars, real-time relay of controls, and display of relevant data. A gameplay is next initialized amongst the player profiles with the central computing device (Step C). The gameplay includes activation and coordination of stimuli within the corresponding control pod with movement of the corresponding automated avatar. Real-time environment data is then continuously captured with each automated avatar during the gameplay (Step D). In this way, the positional coordinates, velocity vectors, video data, audio data, atmospheric data, and more may be utilized by a user in order to make in-game decisions. Next, the real-time environment data of the corresponding automated avatar for each player profile is continuously outputted with the corresponding pod during the gameplay (Step E). Thus, the user is presented with relevant environmental information, as well as information regarding the status of the automated avatar. Next, each player profile is prompted to enter at least one avatar instruction with the corresponding pod during the gameplay (Step F), as represented in FIG. 3. The at least one avatar instruction may relate to inputs from a variety of different controls, including any combination of buttons, levers, joysticks, foot pedals, motion controls, and more. The avatar instruction of at least one arbitrary account is executed with the corresponding automated avatar during the gameplay, if the avatar instruction is entered by the arbitrary profile, wherein the arbitrary profile is any profile from the plurality of player profiles (Step G). In this way, the user may provide directions to the automated avatar as desired. Finally, a plurality of iterations is executed for Steps F through G, until at least one winner profile is designated by the central computing device, wherein the winner profile is from the plurality of player profiles (Step H). Thus, the user may relay instructions according to feedback during the preferred usage of the present invention.

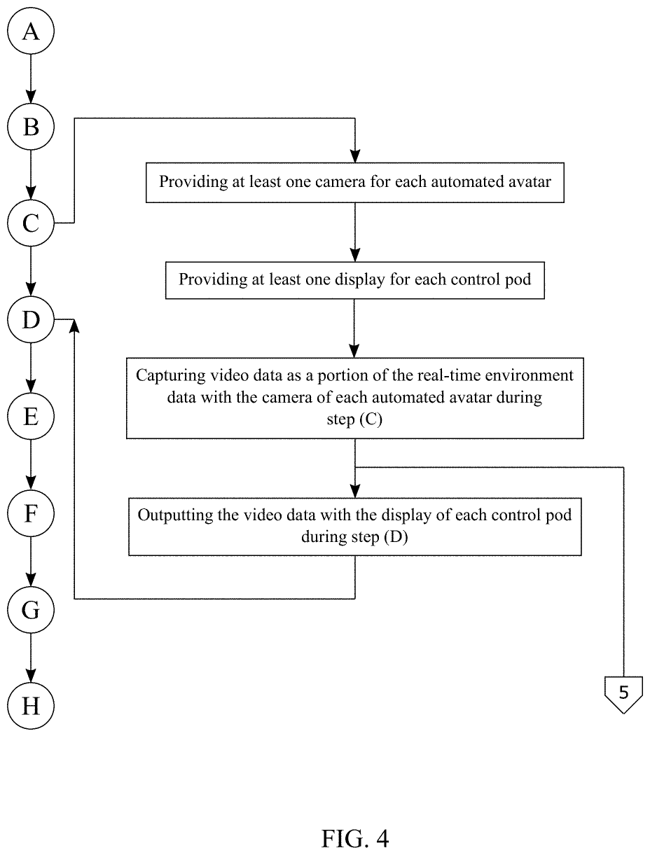

In order to allow a user to experience first person action from a variety of perspectives within the automated avatar, an automated avatar must be equipped with advanced imaging technology. To this end, at least one camera may be provided for each automated avatar, as represented in FIG. 4. The at least one camera may relate to video capturing devices arranged across, around, and within each automated avatar. Such cameras may utilize a variety of technologies and lenses in order to capture an optimal amount and quality of video data. At least one display may be provided for each control pod. The at least one display is a monitor which enables presentation of video data to a proximal user. In an exemplary embodiment, the at least one display may be a VR headset screen, enabling users to engage with the automated avatar from a first-person perspective. In an alternative embodiment, the at least one display may further be a touchscreen interface, enabling users to interact with information presented through touch controls. Video data is then captured as a portion of the real-time environment data with the camera of each automated avatar during Step C. The video data may include video footage of the environment surrounding the automated avatar, the space within the automated avatar where applicable, front-facing camera views, and more. The video data is next outputted with the display of each control pod during Step D. Thus, a user situated within a control pod may utilize video data from the automated avatar in order to make real-time gaming decisions.

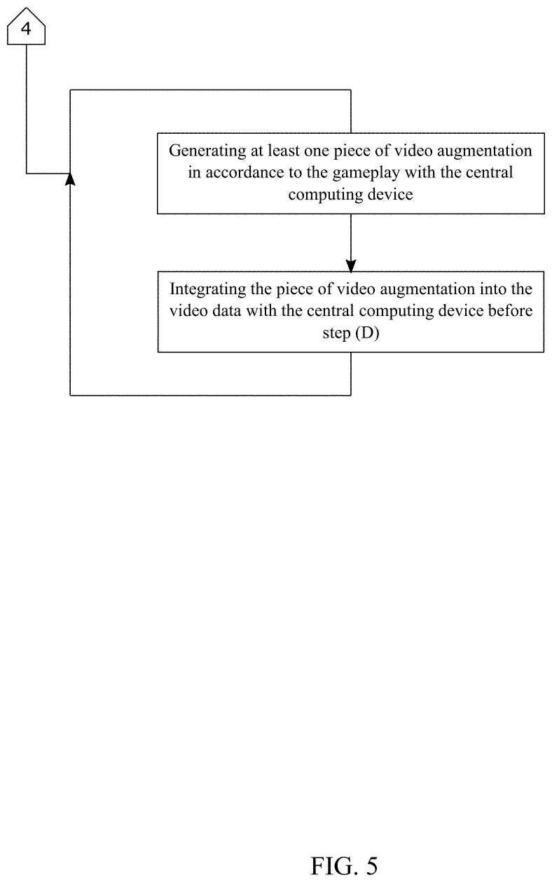

Video data may further be supplemented with appropriate artificial visuals in order to enhance gameplay of various types. To this end, at least one piece of video augmentation may be generated in accordance to the gameplay with the central computing device, as represented in FIG. 5. The at least one piece of video augmentation may include a variety of supplemental visuals, such as fuel gauges, altitude gauges, weapons systems information, in-game team information, maps, health bars, and more as applicable for a particular automated avatar. The piece of video augmentation is then integrated into the video data with the central computing device before Step D. Thus, the video augmentation may contribute to a user's decision-making process, enabling better results and more immersive gameplay.

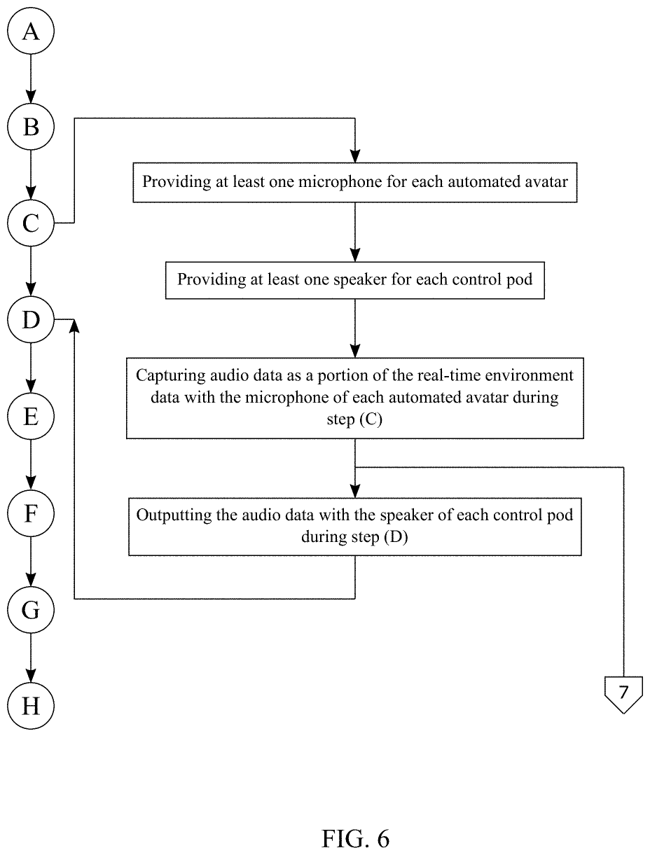

Many game modes require that a user engage with audio data, especially in conjunction with video data. To achieve this, at least one microphone may be provided for each automated avatar, as represented in FIG. 6. The at least one microphone relates to an electronic sensor capable of converting ambient sound waves into electronic signals. Further, at least one speaker may be provided for each control pod. The at least one speaker may be positioned in optimal locations within the control pod or may be integrated into a headgear or other equipment. Audio data is then captured as a portion of the real-time environment data with the microphone of each automated avatar during Step C. Audio data may include both internal automated avatar noises, such as engine sounds, propellor noises, gears or wheels turning, alert sounds, and more as applicable to a particular automated avatar, as well as external noises, such as wind or water noises, other automated avatars, and more as applicable to a particular environment. Ultimately, the audio data is outputted with the speaker of each control pod during Step D. In this way, a user may be provided with, and subsequently respond to, audio cues from the automated avatar during use.

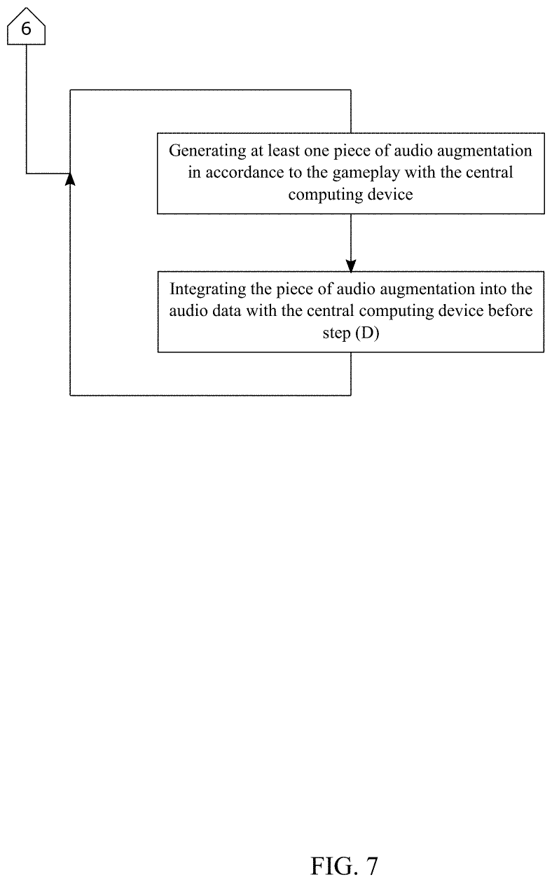

Audio data may further be supplemented with appropriate artificial sounds in order to enhance gameplay of various types. To this end, at least one piece of audio augmentation may be generated in accordance to the gameplay with the central computing device, as represented in FIG. 7. The at least one piece of audio augmentation may include a variety of supplemental sounds, such as engine noises, wind movement, weapons systems activating, alert sounds, and more as applicable for a particular automated avatar. The piece of audio augmentation is then integrated into the audio data with the central computing device before Step D. Thus, the audio augmentation may contribute to a user's decision-making process, enabling better results and more immersive gameplay.

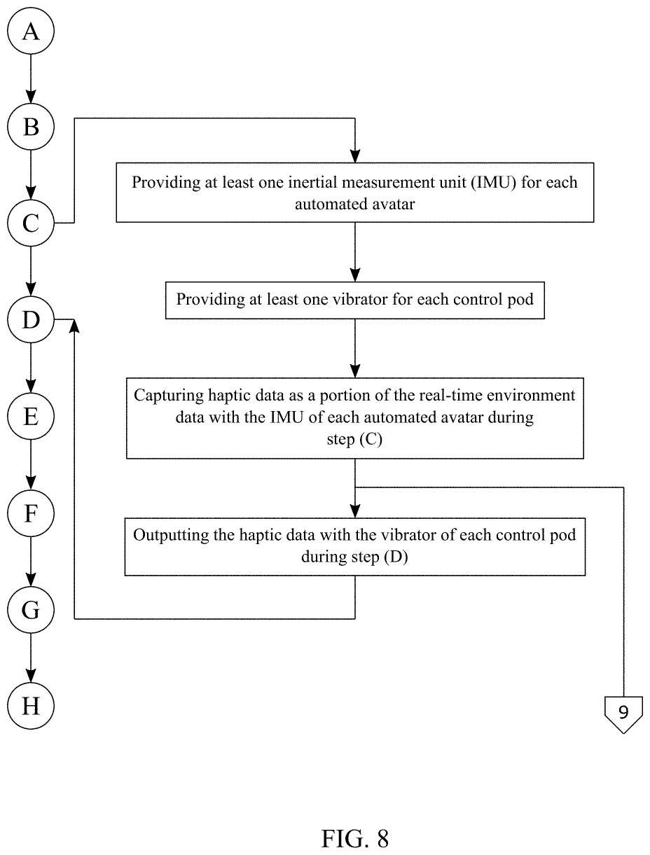

Different scenarios may provide opportunities for more advanced immersive feedback from the automated avatar. To enable such feedback, at least one inertia measurement unit (IMU) may be provided with each automated avatar, as represented in FIG. 8. The at least one IMU relates to a set of accelerometers and motion sensors capable of measuring small displacements in the position of the automated avatar. At least one vibrator is provided for each control pod. The at least one vibrator may be any of a variety of mechanisms capable of oscillating the control pod and/or components within the control pod. Haptic data is captured as a part of the real-time environment data with the IMU of each automated avatar during Step C. This haptic data corresponds to vibration motion detected by the IMU during use. Such data may be the result of external stimuli, such as item usage or crashes, as well as internal stimuli, such as an engine running, equipment failures, and more. Next, the haptic data is outputted with the vibrator of each control pod during Step D. In this way, a user may experience a more intensely immersive gaming experience, as feedback from the automated avatar can generate vibrations within the control pod.

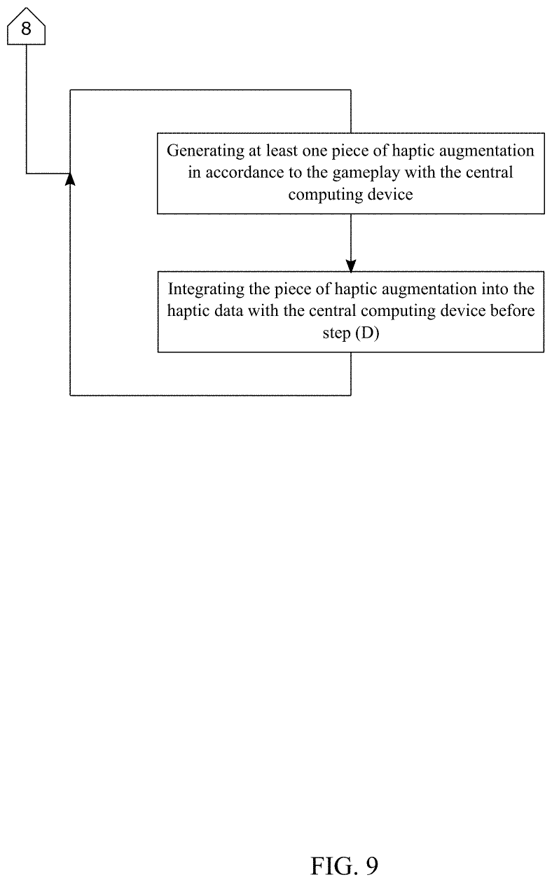

The user experience within a control pod may further be supplemented with appropriate artificial vibrations in order to enhance gameplay of various types. To this end, at least one piece of haptic augmentation may be generated in accordance to the gameplay with the central computing device, as represented in FIG. 9. The at least one piece of haptic augmentation may include a variety of supplemental movements, such as bumps, collisions, weapons systems firing, wing oscillations due to harmonic resonance with the wind, and more as applicable for a particular automated avatar. The piece of haptic augmentation is then integrated into the haptic data with the central computing device before Step D. Thus, the haptic augmentation may contribute to a user's decision-making process, enabling better results and more immersive gameplay.

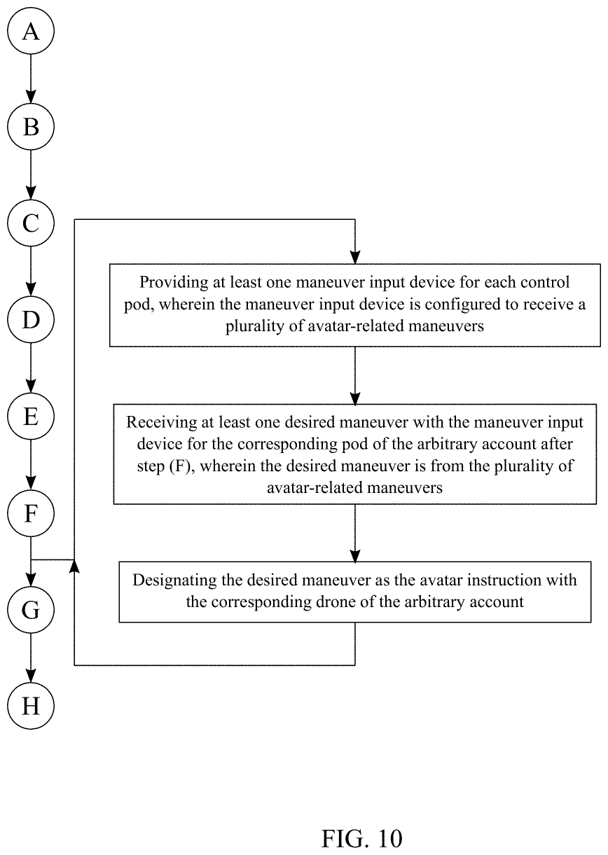

A user experiencing immersive video, sounds, and haptic feedback requires an appropriate mechanism with which to interact with an automated avatar. To this end, at least one maneuver input device is provided for each control pod, wherein the maneuver input device is configured to receive a plurality of automated avatar-related maneuvers, as represented in FIG. 10. The at least one maneuver input device may relate to any or any combination of steering wheels, pedals, hand controls, touchscreen controls, motion control sensors, levers, buttons, switches, and more as applicable for a given automated avatar. At least one desired maneuver is received with the maneuver input device for the corresponding pod of the arbitrary profile after Step F. The at least one desired maneuver is an electronic input sent from the at least one maneuver input device and subsequently correlated to a desired action, such as turning, accelerating, braking, or more. Finally, the at least one desired maneuver is designated as the avatar instruction with the corresponding avatar of the arbitrary account. This arrangement ensures that the corresponding avatar receives interpreted instructions relating to specific necessary changes, such as shifting wing/wheel parts, adjusting propellor/motor velocities, adjusting engine output, and more as applicable to the corresponding automated avatar.

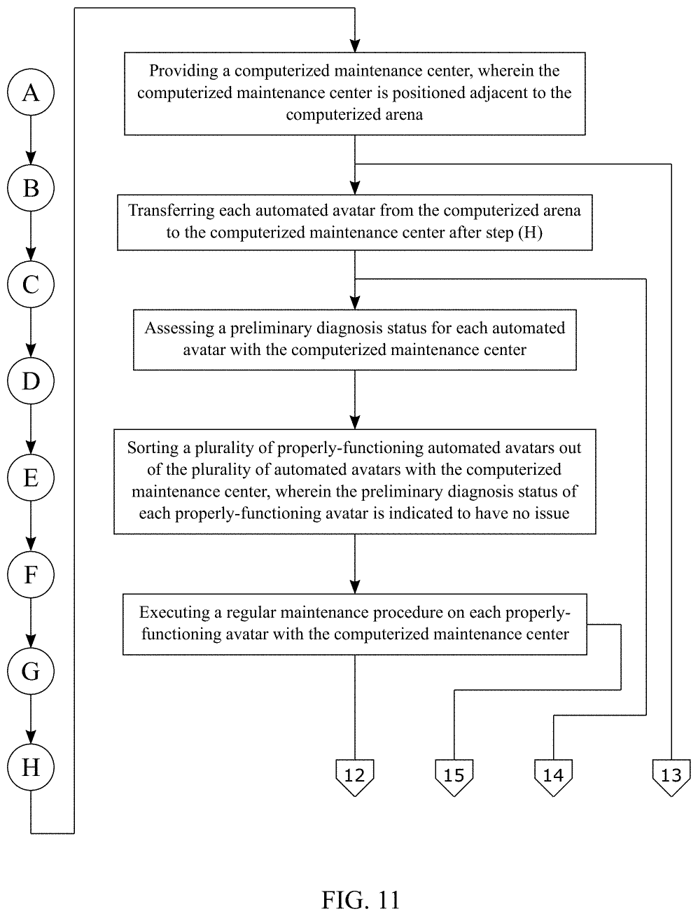

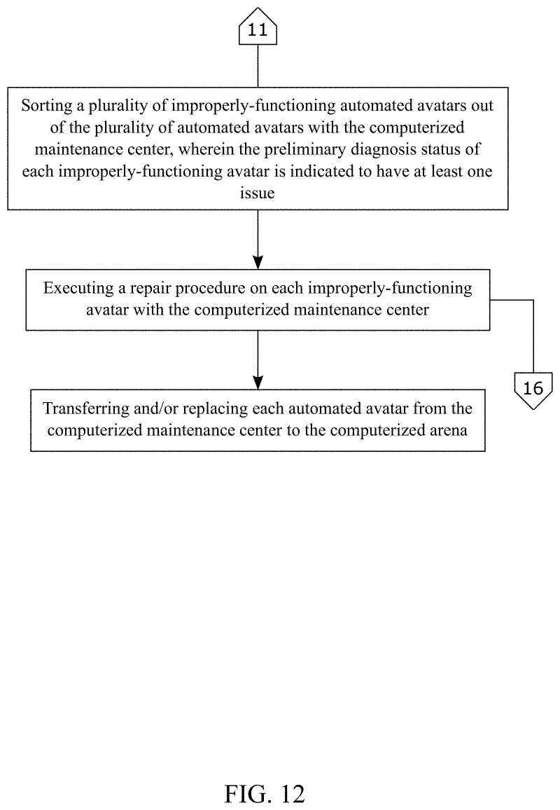

As it is common for various drones and RC units to become damaged or to require service between uses, the present invention requires a method by which to address avatar maintenance. To this end, a computerized maintenance center is provided, wherein the computerized maintenance center is positioned adjacent to the computerized arena, as represented in FIG. 11. The computerized maintenance center relates to a system of automated machinery optimized for engagement with the plurality of automated avatars. Each automated avatar is transferred from the computerized arena to the computerized maintenance center. This arrangement enables each automated avatar to physically interact with the computerized maintenance center. A preliminary diagnosis status for each automated avatar is assessed with the computerized maintenance center. The preliminary diagnosis status is an automated system review of the status of the various components of each automated avatar. A plurality of properly-functioning automated avatars is sorted out of the plurality of automated avatars with the computerized maintenance center, wherein the preliminary diagnosis status of each properly-functioning automated avatar is indicated to have no issue. Properly-functioning automated avatars are those experiencing common issues, such as fuel resource depletion, minor engine overheating, snapped plastic needs, and other similar routine system requirements as required by the automated avatar type. A regular maintenance procedure is then executed on each properly-functioning automated avatar with the computerized maintenance center. The regular maintenance procedure may include refueling, engine cooling, lubrication of moving pieces, and more. Similarly, a plurality of improperly-functioning automated avatars is also sorted out of the plurality of automated avatars with the computerized maintenance center, wherein the preliminary diagnosis status of each improperly-functioning automated avatar is indicated to have at least one issue, as represented in FIG. 12. The at least one issue generally relates to uncommon damage, such as catastrophic wing damage, hull breaches, engine failure, electrical system failures, and more. A repair procedure is then executed on each improperly-functioning automated avatar with the computerized maintenance center. The repair procedure may include component replacement, engine diagnostics and service, electronics replacement, and more. The repair procedure may be automated for several types of failures, but also may require input from human staff or other support roles in more extreme cases. Finally, each automated avatar is transferred from the computerized maintenance center to the computerized arena. Thus, automated avatars are maintained between uses, enabling an optimal deployment schedule that prevents long wait times for users and reduces potentially high equipment costs.

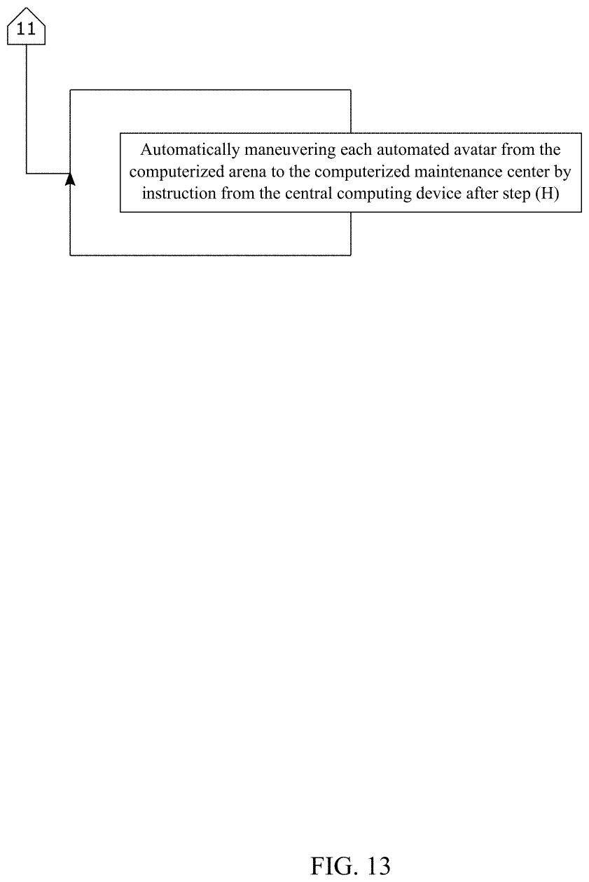

Automated avatars must move to the computerized maintenance center in order to receive required maintenance between uses. To this end, each automated avatar may be automatically maneuvered from the computerized arena to the computerized maintenance center by instruction from the central computing device after Step H, as represented in FIG. 13. This arrangement ensures that the automated avatars can always return to the computerized maintenance center as necessary during or after gameplay.

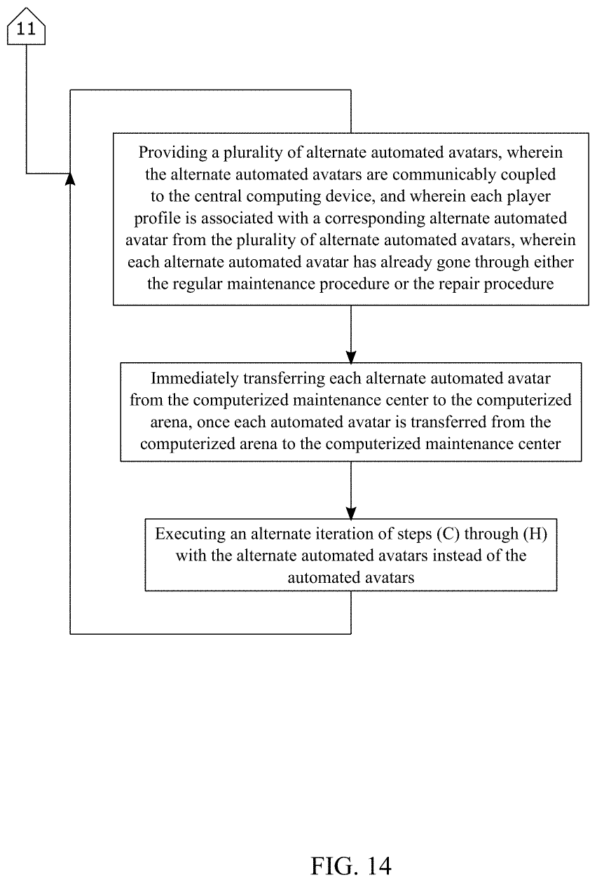

During use, it is possible for an automated avatar to become too damaged to use, necessitating an exchange of automated avatars. To achieve this, a plurality of alternate automated avatars may be provided, wherein the alternate automated avatars are communicably coupled to the central computing device, wherein each player profile is associated with a corresponding alternate automated avatar from the plurality of alternate automated avatars, and wherein each alternate automated avatar has already gone through either the regular maintenance procedure or the repair procedure, as represented in FIG. 14. The plurality of alternate automated avatars represents a set of avatars that have been placed on standby to ensure, especially from the user's perspective, a smooth transition between automated avatars. Each alternate automated avatar is immediately transferred from the computerized maintenance center to the computerized arena, once each automated avatar is transferred from the computerized arena to the computerized maintenance center. This arrangement ensures that the prior automated avatar is removed from play and disconnected from signals from the corresponding player profile before the new avatar is in position. Next, an alternate iteration of Steps C through H is executed with the alternate automated avatars instead of the automated avatars. Thus, the alternate automated avatars are on standby in advance of their usage during gameplay.

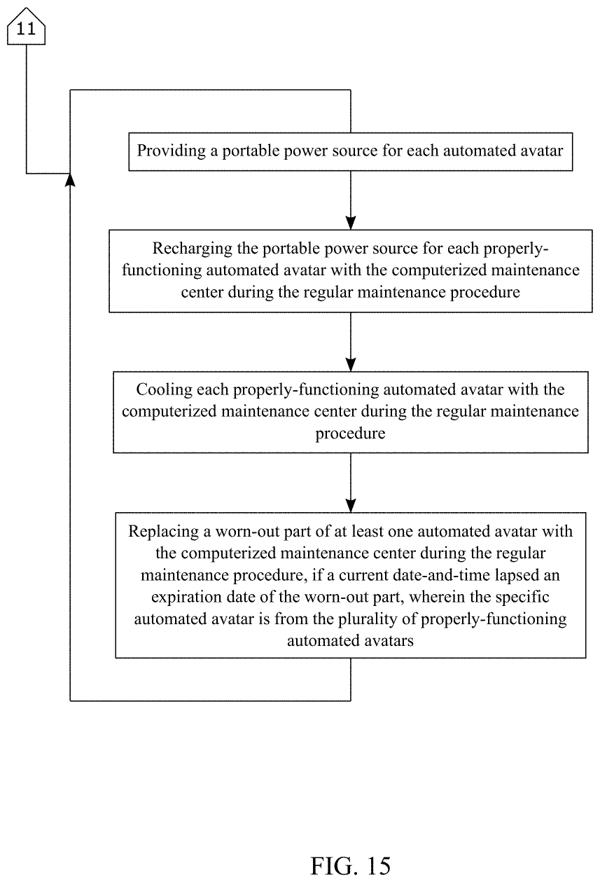

Properly-functioning automated avatars may undergo a variety of procedures in order to ensure optimal performance during use. To facilitate this, a portable power source may be provided for each automated avatar, as represented in FIG. 15. The portable power source denotes any of a variety of electronics, including batteries or battery arrays, charge convertors, invertors, and any other necessary common electronic components, which can provide each automated avatar with electrical power during operation. The portable power source is recharged for each properly-functioning automated avatar with the computerized maintenance center during the regular maintenance procedure. Thus, each properly-functioning automated avatar receives the electronic power necessary to maintain communications and systems during use. Each properly-functioning automated avatar is next cooled with the computerized maintenance center during the regular maintenance procedure. The cooling phase prevents potential damage due to thermal fatigue, especially with respect to the portable power source and other electronic components, which are especially vulnerable to failure when exposed to poor thermal conditions over time. A worn-out part of at least one automated avatar may be replaced with the computerized maintenance center during the regular maintenance procedure, if a current date-and-time lapsed an expiration date of the worn-out part, wherein the specific automated avatar is from the plurality of properly-functioning automated avatars. In a preferred embodiment, such parts as casings, chassis, wings, wing tunnels, propellors, wheels, and more may be 3D-printed on-site, thus reducing material overhead and facilitating avatar repair.

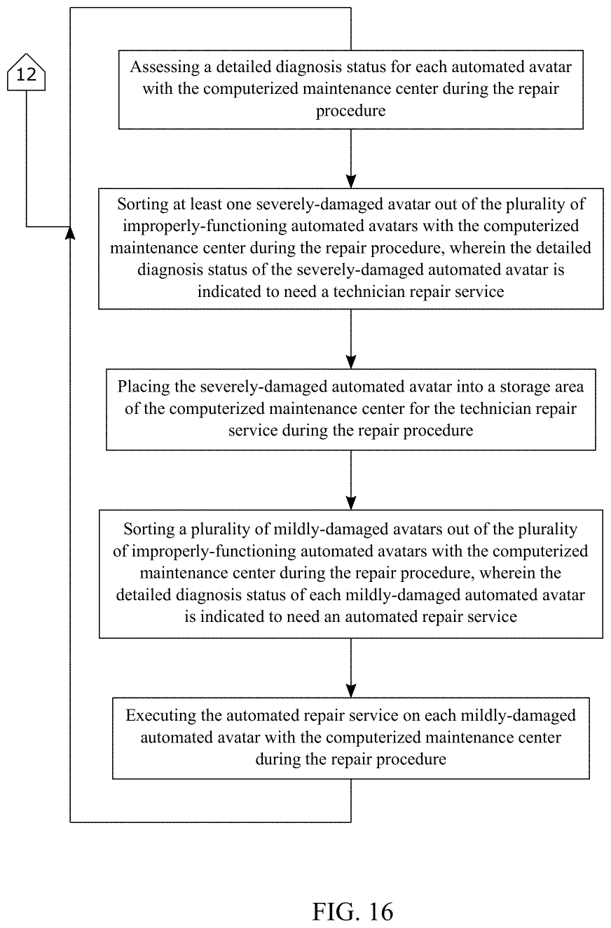

The plurality of improperly-functioning automated avatars may require a variety of different maintenance repairs in order to return to functional, game-ready quality. To this end, a detailed diagnosis status is assessed for each automated avatar with the computerized maintenance center during the repair procedure, as represented in FIG. 16. The detailed diagnosis status is generated as a result of evaluation of all critical systems within a given automated avatar, such as signals, power systems, engine, gear drive, sensors, and more. At least one severely-damaged automated avatar may be sorted out of the plurality of improperly-functioning automated avatars with the computerized maintenance center during the repair procedure, wherein the detailed diagnosis status of the severely-damaged automated avatar is indicated to need a technician repair service. The severely-damaged automated avatar may require complex repairs to any of the aforementioned systems, or any combination of those systems, which the computerized maintenance center is not appropriately equipped to repair automatically. The severely-damaged automated avatar is then placed into a storage area of the computerized maintenance center for the technician repair service during the repair procedure. In this way, the severely-damaged automated avatar is separated from other automated avatars until the repair procedure is complete, at which point the severely-damaged automated avatar may rejoin the plurality of automated avatars that are prepared for deployment. Similarly, a plurality of mildly-damaged automated avatars is sorted out of the plurality of improperly-functioning automated avatars with the computerized maintenance center during the repair procedure, wherein the detailed diagnosis status of each mildly-damaged automated avatar is indicated to need an automated repair service. The automated repair service may include procedures such as basic part replacement, sensor replacement, or more. The automated repair service is then executed on each mildly-damaged automated avatar with the computerized maintenance center during the repair procedure. In this way, each of the plurality of mildly-damaged automated avatars is fixed efficiently and returned to the plurality of automated avatars that are prepared for deployment.

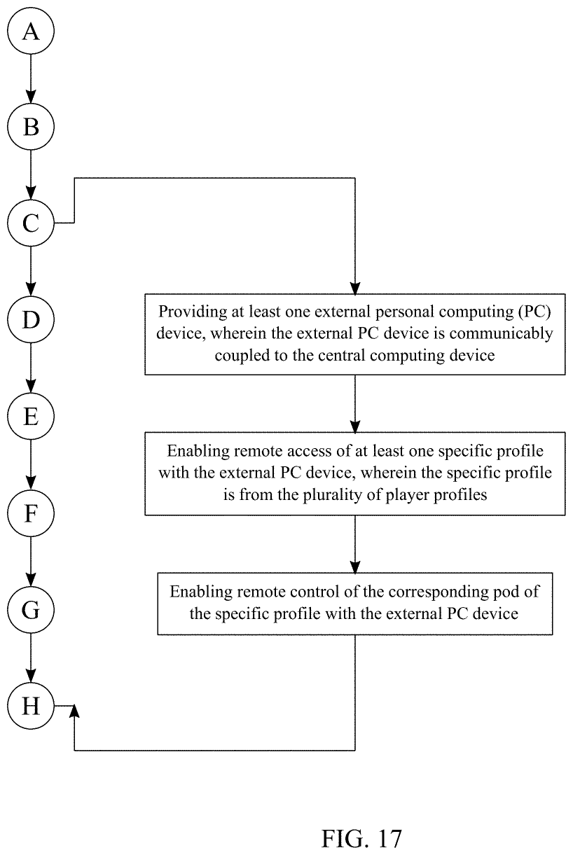

A user of the present invention may have appropriate equipment available at their place of residence and may therefore want to engage with a control pod remotely from a dedicated facility. To this end, at least one external personal computing (PC) device may be provided, wherein the external PC device is communicably coupled to the central computing device, as represented in FIG. 17. The external PC device may relate to any of smartphones, desktop computers, laptop computers, smart devices, or any other electronic device capable of remotely connecting to the internet. Remote access of at least one specific profile is then enabled with the external PC device, wherein the specific profile is from the plurality of player profiles. This arrangement grants the external PC device permission to interact with the present invention. Finally, remote control of the corresponding pod of the specific profile is enabled with the external PC device. Thus, an appropriately-equipped enthusiast can manipulate a control pod, and a corresponding automated avatar, remotely as desired.

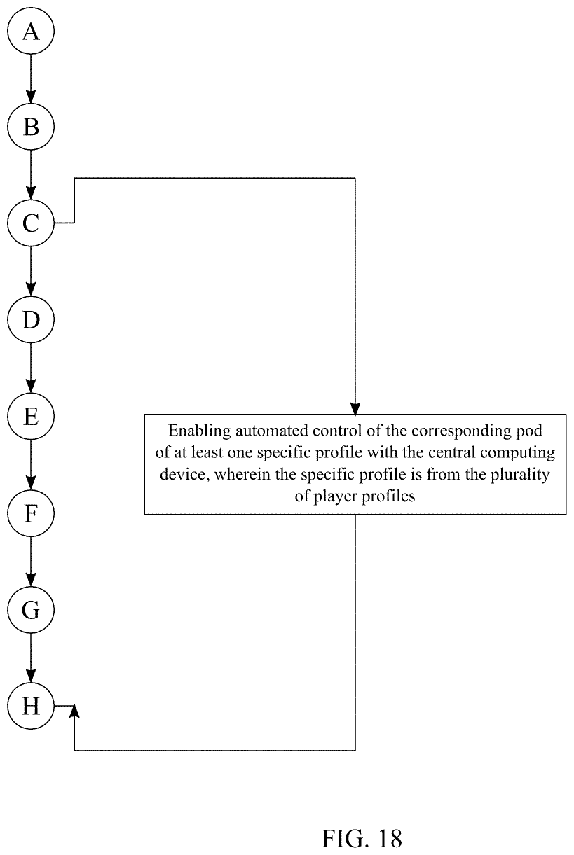

It may be the case that a player requires a partner for gameplay and does not have anybody available. To address this issue, automated control of the corresponding pod of at least one specific profile may be enabled with the central computing device, wherein the specific profile is from the plurality of player profiles, as represented in FIG. 18. In this way, an artificial intelligence can control automated avatars as necessary to fill a lobby. Similarly, automated control may be assumed for players who are absent or need a break from a game, thus preventing a lapse in gameplay. Each automated avatar is automatically maneuvered by instruction from the central computing device if there is no player profile for at least one gameplay pod.

### Supplemental Description

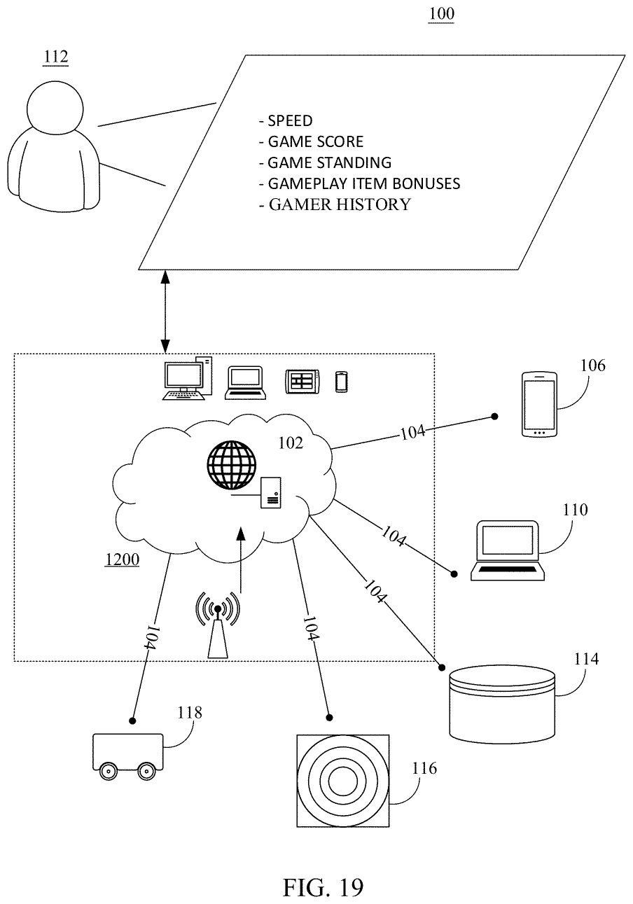

As can be seen in FIGS. 19 through 29, the present disclosure includes many aspects and features. Moreover, while many aspects and features relate to, and are described in the context of mixed reality competitive gameplay to facilitate competition among multiple users, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touchscreen interface, voice-based interface, gesture-based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third-party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine-readable secret data (e.g. encryption key, decryption key, bar codes, etc.) and/or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps). Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

As an overview, the present disclosure may describe mixed reality competitive gameplay to facilitate competition among multiple users. Further, the disclosed mixed reality competitive gameplay may use realistic controller environment to allow one or multiple users to control a remote-controlled drone and compete against other users/teams in a course, track or arena. Further, the mixed reality gaming concept may utilize a realistic controller cockpit or simulated environment to allow one or multiple users to control a remote-controlled vehicle/machine through a course or track to compete against others. Further, the disclosed methods, systems and apparatuses for mixed reality gaming may include one or more cockpit/simulated control devices and one or more remotely-controlled drones, including providing game control software that connects remote controlled drones to the various user control devices/environments. This game control software monitors user success, allow for quick change in hardware/devices for continual gameplay, including rules for play affecting the operation of the remotely-controllable drones. This may also include virtual assets or objects displayed within the play environment that the user can use their RC drone to interact with for gameplay. Tracks and courses could be hyper-realistic environments that have moving elements that make gameplay more interactive and challenging.

Further, the disclosed methods, systems and apparatuses related to the mixed reality and electronic gaming industry, particularly games may use realistic controller environments that transport users to the driver's seat of remote-controlled drones for competitive gameplay. These games could be mobile and set up in a traveling unit so users could experience the games in parking lots, malls, or other public areas. These games could also be set up in dedicated entertainment centers where experiences could be built out to be higher quality, more complex, and larger in scale. Further, the disclosed mixed reality competitive gameplay may fill the gap between complex aerial drone racing and eSports by creating a mixed reality gaming experience, systems and apparatuses to have a user truly become a part of the gaming experience. They enter into a controlled environment, such as a driver's cockpit or life-size representation of the type of remote-controlled drone, that allows them to operate individual or multiple remote-controlled drones throughout a track or course to compete against other users in a similar control environment. This does not include aerial drones due to the licensing and complexity in operation but remains ground and water operational like a Remote Control Car, boat, or submersible. This makes the experience easy to grip for brand new users and not require as many maintenance costs from broken pieces. These vehicles could become airborne for small periods of time from jumps and other obstacles but does not operate similar to an aerial drone with sustained flight. Further, the track or course may be magnetized to maintain the RC Drone from excessive flipping/overturning during game play. In an embodiment, the track and RC unit(s) may be magnetized dependent on the gameplay type, so the RC units can be flipped, can turn over automatically or with some other means to maintain gameplay, such as a mechanical arm or manually by a trained staff member. The environments that the remote-controlled drones operate in could be hyper-realistic and scaled to make the user feel as though they are truly inside the environment. This creates a unique perspective within the gameplay that is not represented anywhere else in the marketplace.

All of the data from the gameplay for each remote-controlled drone feeds back into a central gaming software and feeds directly back into the control system to reduce latency in the signal to make gameplay responsive and smooth to the user. Additionally, units are able to be switched out and registered back into the gaming software using technologies like RFID to identify their unique transmission signal to improve continuous gameplay and allow users to even enter in their own custom build remote-controlled drones for tournaments, camps, or competitions. This also allows the remote-controlled drones to be interchanged quickly so that they can remain cool in temperature and allow time for battery changes/recharging without halting the gameplay experience between rounds.

The gaming software may also utilize Artificial Intelligence (AI) driven controls to make remote-controlled drones go back to the reset point for gameplay start or for switching themselves out when reaching a higher temperature or low battery range. This improves the gameplay experience for users so that there is no lag between rounds. This method, systems, and apparatuses for mixed reality gaming can be adapted to different scenarios over time such as competitive RC car racing through scaled environments or simulated tanks that can battle within an arena. Hardware and controllers may be a combination of custom 3D printed parts, third party manufactures, and internally build parts. These can change and be adapted overtime to give the user the best experience possible and reduce operational costs.

The remote-controlled drones could also utilize sensors and other feedback data to the control units to give physical/sensory feedback to the users, such as vibration or haptic movement from gameplay. As well as vice versa, the control units and mixed reality/virtual reality headsets could send data to the remote-control drone controlling its movement or action. For instance, user's head movement could control the first-person view camera movement on the remote-controlled drone. This sensor information from the remote-controlled drone could also provide data back to the user such as speed, game score/standing, and any other information pertinent to gameplay rules. This data is displayed within the mixed reality/virtual reality headset as a Heads-Up Display (HUD), or it can be translated to the user using audio feedback. All game play and first-person views can be viewed by spectators watching the mixed reality competitive gameplay either through displays and/or external mixed reality/virtual reality headsets that are streaming the view of players. This gameplay footage can also be streamed live through online gaming platforms and esports providers such as Twitch™, in compliance with that third party's usage rules. Gameplay may grow and evolve as new technologies become available such as allowing users to shoot projectiles either real or virtual at other game players remote-controlled drones, within that specific gameplay rules. Gameplay software is utilized to integrate mixed reality/virtual reality headsets, sensor data from sensory devices, microcontrollers for movement of remote-controlled drone, gameplay rules, audio output, and remote-control drone functions/movement so that everything is a part of the same cohesive experience from users.

Gameplay rules include single races or rounds, tournament style, and league style play with the champions sometimes receiving trophies, rewards, and other types of wmnmgs. Mixed-Reality Competitive Gaming System that uses “life-size” controller containment units and conveyor methods to allow one or multiple users continuous gameplay controlling a remote-controlled drone through an interactive, controlled and smart gameplay environment. Mixed Reality Gaming concepts, systems, methods and apparatuses may bring a new generation of competitive entertainment experiences to market in the Gaming industry. This mixed reality gaming concept utilizes “life-size” realistic controller containment units to reproduce the experience of a Remote Controlled (RC) Drone (AKA RC Unit) in an interactive, complex, and scaled gameplay environment. The smart gameplay environments may include a conveyor system that allows for continuous gameplay using RC drones and solves major problems associated with using RC drones for competitive gaming. This conveyor system allows the RC drones to enter, be diagnosed, sorted, cooled, recharged, repaired, and other similar functions. They can then be replaced or reintroduced into gameplay between rounds or during gameplay dependent on gameplay type. During exit and reintroduction, the RC Unit is identified uniquely through the identification reader zone within the conveyor system, which contains RFID, Bluetooth and/or other similar identification technologies. The gameplay engine then dynamically takes this ID to reprogram and to match the radio frequency of the Remote Controller housed in the RC Controller Containment Unit. This can result in actions like light color response on the RC drone to match the controller containment unit's color scheme (shows audience who is who on track) or a multitude of other functions dependent on game type, such as team. This gameplay system can also take control of the RC drones using Artificial intelligence/Machine learning/neural network technologies or other similar programming technologies in-between rounds for reset and conveyor entrance/exit, or during gameplay to replace an empty player position so other users can still have competition against a Central Processing Unit (CPU) if there is not a full player roster in all RC controller containment units for a specific gameplay environment (track/arena/battleground/etc.). This is all used to create little to no downtime between rounds for users to enjoy, produce continuous gameplay during working hours so it is profitable for the facility/owner to operate such a system, and solves the issues plagued with using RC drones (short battery spans, overheating, often service needs, etc.) for gameplay. The system dramatically and non-obviously improves upon previous concepts to create a system that is cost-effective, quality controlled and able to be taken to market in an unparalleled way.

Game types can be built upon or whole new game concepts developed using this as the basis of functions for gameplay. For instance, one build out environment could be similar to an RC Racing game where users race around a track that changes or throws things at the user to avoid, while they sit in a life-size drivers cockpit seeing from a 360-degree camera (or camera on gimbal) what the RC unit is seeing (reacting to head motions of the user with Virtual reality (VR) I Mixed Reality (MR)/Augmented reality (AR) headsets), feeling the twists of the track and actions of gameplay (haptics/sounds/motion/vibration of controller or controller containment unit). Another variation could be to have several users within a single RC Controller containment unit, controlling different aspects of the same RC drone/unit, say in a tank game where one person controlled the main shooter, another drives, and another is lookout/gunner on top of tank. These systems, methods, and apparatuses could also be adapted to create a submersible game where users are inside of a submarine-like RC Controller Containment Unit controlling an RC submarine in a controlled, smart water tank gameplay arena.

Gameplay types can extend to many varying themes, such as water boats on an everglades themed map or dune buggies/motorcycles on an Egyptian sand dune themed gameplay map. This could also include virtual assets or objects displayed within the play environment that the user sees through their VR/AR/MR Headsets that they can use their RC drone to interact with for gameplay. An example of this would be unlocking certain gameplay elements of their RC unit, such as projectiles or reducing other player's power by % for a certain period of time. Gameplay Arena/Environment could be hyper realistically scaled, futuristic in design, or video game like designed and have moving elements that make gameplay more interactive and challenging. Moving elements may also be manipulated by onlookers or other players during gameplay dependent on game type.

Further, the disclosed mixed reality competitive gameplay relates to the mixed reality and electronic gaming industries, particularly games that use realistic controller environments that transport users to the driver's seat (referring to a racing example game) of remote-controlled drones for competitive gameplay. These games and gameplay arenas are mostly self-sustaining looped systems that could be mobile and set up in a traveling unit so users could experience the games in parking lots, malls, or other public areas. These games could also be set up in dedicated Entertainment Centers, their principle application, where experiences could be built out to a larger scale, be higher quality, and more complex. Further, the disclosed mixed reality competitive gameplay is broken down into seven core functional areas:

### 1. Gameplay Engine/Software/Server

### 2. Gameplay Arena/Environment

### 3. Conveyor System

### 4. RC Units/Drones

### 5. RC Controller(s)

6. RC Controller Containment Unit (“life-size” representation)

### 7. Safety System(s)

These systems may vary slightly in their internal structure based on the gameplay type but involve one, some or all of the same basic functional areas. This could include combining or eliminating certain system areas to improve performance or to accommodate the gameplay type. Gameplay rules include single races, battles or rounds, tournament style, and league style play with the champions sometimes receiving trophies, rewards, and other types of winnings. Further, the disclosed mixed reality competitive gameplay may introduce brand new concepts in manufacturing using 3D printed parts at scale to build out the RC Units, RC Controllers, RC Controller Containment Units, and Gameplay Arenas. Not every piece is able to be 3D printed but the majority of body parts can be, which allows for local or onsite repair that substantially lowers costs of a system as large in scale as described. Audiences are able to view the 3D printing process through viewpoints at specific locations where this mixed reality gaming system/platform is set up.

The known prior art overall describes systems that do not match the current inventions scale, solutioning, design, commercial viability or impact. The disclosed methods, systems, and apparatuses create a competitive mixed reality gaming system that creates a mass-market viability and solves some of the most prevailing issues in the markets of mixed reality gaming and remote-controlled drone games. Further, the disclosed methods, systems, and apparatuses control the gameplay environment, creating a Gameplay Arena (could also be referred to as a track, court, area, stadium) that has a built-in Conveyor System (may be hidden to the view of users/audience, but accessible to facility professionals trained in the art) that creates the ability of limited lag time between sessions. This Conveyor System features many benefits to gameplay and creating a commercially viable competitive gaming experience, features described in greater length. But one major benefit of this conveyor system is its ability to allow RC units to be switched between gameplay sessions, allowing for the same experience in each round of gameplay (i.e. no overheating of the unit, lower speed power or running out of battery as examples). This all happens in a matter of moments, using the Identification Reader method, allowing there to be little to no lag time between sessions. The disclosed methods, systems, and apparatuses create a full system that creates a brand new experience in competitive mixed reality gaming by taking control of the landscape of the game.

Further, the disclosed mixed reality competitive gameplay includes dynamic landscapes that are scaled to create a unique gaming experience from the vantage point of the user, such as driving through a volcano island track mentioned before, the sand dunes of the dessert or submersibles in the great shark reef. This dynamic field changes similar to a Disney or Universal Studio ride, with varying themes using the latest techniques in real-world or virtual special effects creation and modeling. This controlled environment (Gameplay Arena) would go beyond just controlling the field of play to create a scalable competitive experience but may also include the programming of the RC units to take commands from the central gaming server/engine. This allows them to be controlled by machine learning, artificial intelligence, a neural network or similar programming to help dynamically control the RC unit for reset/service between rounds or replacing an empty player seat. For instance, if an RC car is running low on battery or approaching a critical heat level, once that round is completed the gameplay engine would take control of the vehicle guiding it into the service conveyor previously discussed, with a replacement unit entering the gameplay arena to take its place. The system of the present invention is packaged in a scalable fashion that can be taken to mass market and played by nearly anyone. The system focuses not only on gameplay but reducing downtime, ensuring safety, and creating a scalable experience that can be dynamically changed to new game types or new facilities. This system creates the magic of the game by not making users recharge the batteries themselves, or see a person swapping the RC Units in and out. It is a closed-loop system that creates an experience for players and onlookers that can be played during nearly all facility/venue open hours, for example—hours per day. The present invention utilizes a conveyor that takes these RC Units and services them through automation and professional staff and instantly replaces that unit in gameplay, reprogramming the life-size RC Controller Containment Unit and RC Controller to match the new RC unit's radio frequency (RF) or similar signal type. This system allows for scalability as RC units and gameplay types become more complicated, and the technology in the conveyor and arena becomes more advanced. For instance, the Conveyor System could refill gameplay ammunition, replace broken pieces with D printed repairs automatically or even allow a team of technicians to service the RC unit during gameplay (almost like Formula cockpit services during race). This invention system allows for continued competitive gameplay by handling the challenges of current day RC Unit devices with a mix of AI, machine learning, neural network, and conveyor technologies. The disclosed methods, systems, and apparatuses create a user experience that tracks a user's history, points and gameplay ranking to create a competitive gaming experience that is similar to online video games. The current invention also allows users to form teams that build their own RC units (within the confines of the game rules for that league) and race them across facilities and different gameplay arenas in a league/championship style of play. This promotes innovation, education of youth and engineering advancement in a way that is rarely seen today in gaming. Rather than focusing on at-home Gameplay Arenas or having slow gameplay that has long period of rest time between playing due to battery recharging, overheating or other RC unit challenges, the current invention is a system that produced rapid gameplay session rounds, which allows room to create profitability for the facility but also creates a completely unique user experience, such as what the company TopGolf™ did for golf.

The current invention described provides mixed reality competitive gameplay environments similar to theme park rides with life-size control units users interact with to control a remote control drone through that environment, competing against others. This system could even be scaled to have remote plugin access where users could actually be offsite, and link into the track at a controlled facility not open to the general public or another Gameplay Arena at a normal facility. This allows users in their own at home pods to link into the gameplay arena and join a session against other players, similar to online first-person shooter games today. This system is scalable beyond the mentioned games in the known prior arts to having submersible vehicles racing and/or battling underwater, robots fighting one another, and much more. Lastly, the dynamic reprogramming to change frequencies to a new RC unit to create fast round play in the games through a conveyor system is a concept that is not mentioned anywhere in the known prior art and is a non-obvious solution to people within the field of study.

As can be seen in FIG. 19, by way of non-limiting example, the online platform 100 to a mixed reality competitive gameplay to facilitate competition among multiple users may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, sensors 116, and a RC unit 118 over a communication network 104, such as, but not limited to, the Internet. Further, users of the online platform 100 may include relevant parties such as, but not limited to, end users, game players, and administrators. Accordingly, in some instances, electronic devices operated by the one or more relevant parties may be in communication with the online platform 100. A user, such as the one or more relevant parties, may access the online platform 100 through a web-based software application or browser. The web-based software application may be embodied as, for example, but not be limited to, a website, a web application, a desktop application, and a mobile application compatible with a computing device 1200.

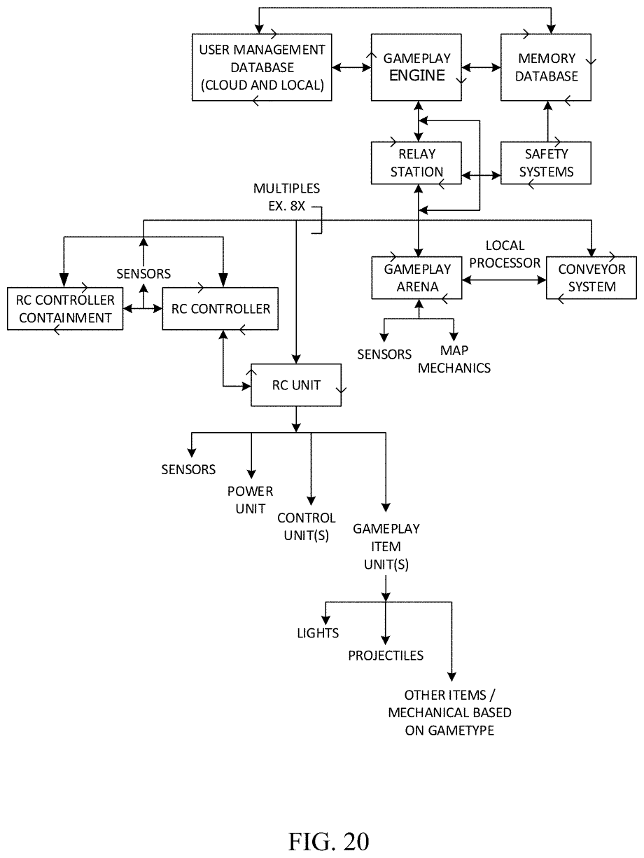

As can be seen in FIG. 20, a system to facilitate mixed reality competitive gameplay is in accordance with some embodiments. Further, the system may include a user management database, a memory database, a gameplay server, an RC unit/drone, an RC controller, RC controller containment unit, a conveyor system, a gameplay arena/environment, a safety system. Further, the user management database may include a database that may be configured to store information associated with a user. Further, the information may include user profile, gamer tag, gamer history/record for ranking, avatar, preferences, and any other information needed for gameplay that may vary by type, such as payment information. Further, the user management database may be cloud-based and local. Further, the user may include an individual that may want to participate in the mixed reality competitive gameplay. Further, the memory database may include a database configured to store information such as game highlights, safety records, user interaction records, and any other information that may improve safety, quality, user experience and/or viewer experience. Further, the gameplay server/engine may include a software that may allow control, monitoring, analysis, output and input across the entire gaming system/platform network of functions and components. Further, the gameplay server may communicate directly with or even house the user management database so that the gameplay server may synchronize player information with the gameplay environments and the memory database. Further, the memory database may be synced between the user management database, the gameplay server/engine and serves to record keeping. Further, the user management database, the gameplay server, and the memory database may include an exposed user interface layer that may allow system staff members (with the correct security permissions) to access, analyze and share information across the system and databases. An example of this would be sharing game highlights/live views on online platforms like Twitch™, Social Media platforms, or YouTube™. This layer of the system is not depicted in FIG. (High Level Interaction Model) because it is assumed that owners/operators of the system need to access any portion of the system at any time to perform maintenance, improve quality, increase safety, and create an amazing experience for its customers/viewers.

Further, the gameplay server may communicate directly with a relay station or directly to other functional areas of the system through Wi-Fi, Bluetooth, /G, direct cable or other data transfer means. Further, data that may be received and transmitted from the gameplay server/engine may include sensor information, gameplay arena monitoring/control, safety system control/monitoring, conveyor system control/monitoring, Remote Controlled (RC) controller containment unit control/interaction/monitoring, RC controller monitoring/responsive input & output, information associated with the user, gameplay, records, etc. Further, upon identifying the RC unit running on low battery or approaching a critical heat level, the gameplay server/engine may take control of the RC unit, guiding it into the service conveyor, with a replacement RC unit entering the gameplay arena to take its place. This is implemented using a robotic operation system, robot process automation, computer vision, artificial intelligence, machine learning, convolutional neural networks or other neural network technologies, speech recognition, development platforms like UiPath, frameworks like PyTorch and TensorFlow, line or marking follower programming, or other similar techniques dependent on game type. Dependent on game time, these automation functions could work with onboard sensors like laser scanners, stereo vision cameras, bump sensor, force-torque sensors, spectrometers, LIDAR, radar, other camera technologies, etc. Further, the RC units/drones may include actual devices on the gameplay arena that players (or users) or a central processing unit (CPU) controls to attempt to win that specific game type. Further, the RC units may be adapted to fit specific game objectives of a gameplay type. For instance, in a racing game, aerodynamic design and/or 4—wheel drive may be the desired objective if facing a sand-dune theme. In another game type, strength may be the objective and gameplay item fuel capacity (example projectile ammo load) may be the build goal. Further, the gameplay type examples may include a racing, a battle royal, a submersible. Further, the racing gameplay type may include a car racing, a buggy racing, a boat/airboat (on water surface) racing, motorcycle racing, and other vehicles (or group type drones) racing. Further, the battle royal gameplay may include tanks, battle robots, etc. Further, the submersible gameplay type may include a submarine racing or battles. Further, the RC units may include varying types of design elements and actual component parts. Further, the RC Units may include one or more components.

Further, the one or more components may include body, battery, gameplay items, action control unit(s) (for specific game-type, deploys gameplay items), motor(s), central processor(s), signal receiver(s), camera(s) (degree or regular), gimbal, sensors, scanners, propulsion system, dampeners (as applicable), actuators, gears & gearbox (if applicable), shock absorbers, body, buoyancy control (if applicable), lighting system (for visual color team/player aid and for gameplay), and other components found in the RC units. Further, the RC Unit may be connected to one or more of the full system components dependent on gameplay type and structure that may increase user/viewer experience. Further, the one or more system components may include RC controller, RC controller containment unit, gameplay arena, conveyor system, relay station and/or the gameplay server/engine. Further, the one or more components of the RC units may be designed and manufactured to be created using 3D printing techniques to lower costs, increase speed of repair, and gain flexibility on location. Further, the RC Units may be designed and built for education/competition purposes. For instance, high school students instructed to design the RC units to compete at a local gameplay arena that may promote education, learning in the technical and engineering arts, and drives innovation. Further, third party organizations may provide their own branded devices upon partnering. Further, the RC controller(s) may include actual physical inputs or audio inputs that may come from the player(s) to control the action of the RC unit(s). Further, the RC controller(s) may be housed inside of an RC Controller Containment Unit. Further, the RC control inputs may vary based on game type and RC unit design but may be audio, direction (steering), power (speed/strength/current), and/or action (projectiles, speed boost, other game type-specific pickups) based. Further, the RC controller may provide a sensory-based feedback to the player based on game action, for instance faulty steering when hit with projectile, or loose force reaction when slipping on virtual or real ice. Further, the sensory-based feedback may be based on the gameplay type. Further, the sensory-based feedback may be vibration, force, and/or movement-based. Further, the RC controller may communicate directly with the RC controller containment unit, RC unit, relay station, gameplay arena, safety systems and/or gameplay server, dependent on the gameplay type. Further, the RC controller may combine with a mixed reality/virtual reality/augmented reality headset for specific gameplay types and may send data to the RC unit controlling movement or action. For instance, user's head movement may control the first person view camera(s) movement on the RC unit or interact with the 360-degree camera's panorama view. Further, sensor information from the RC unit or information from the gameplay server may provide data back to the user through the RC controller such as speed, game score/standing, gameplay item bonuses and any other information pertinent to gameplay rules. Further, the data may be displayed within the mixed reality/virtual reality/augmented headset as a Heads-Up Display (HUD), or it can be translated to the user using audio feedback or other means based on the gameplay type. Further, the RC Controller Containment Unit (CCU) may include a life-size housing for the RC controller that may represent the gameplay action controls of the RC unit for the gameplay type. Further, the RC Controller Containment Units may include enough space for one or more players, seats or control interaction points with the RC Controller(s), and/or visual/sensory inputs/outputs (functions to create a experience: Airflow, heat, cooling, movement, vibration, haptics). Further, the RC Controller Containment Unit may respond to actions by users, the gameplay arena, other players, and/or the RC unit. Further, the actions may include things like causing rotation, vibration, airflow, movement, sounds, lights or other features to make the experience even more real to the player's senses and increase quality. Further, the RC Controller Containment Units may be life-size in the representation of the RC unit. Further, the RC Controller Containment Unit may vary in its appearance, function, design, and action based on the gameplay type. For instance, creating a racing pod for racing type gameplay, full-size body corresponding to a tank for battle royal type gameplay, and a body corresponding to a submarine type for submersible type games. Further, the body may not be an exact representation. Further, the body may be the embodiment of the function and gameplay type purpose. Further, the body may be padded throughout to increase safety in design and may never be a truly sealed area to create easy exit in the unlikely event of an emergency or safety risk. Further, the RC Controller Containment Unit may have gameplay arena components attached, upon fitting gameplay scene and experience for players and/or viewers. Further, the gameplay arena components may include external components such as color matching lights, displays to present Gamer(s) Tag information, and/or score ranking in gameplay type rounds. Further, the external components may vary based on the gameplay type. Further, the RC Controller Containment Units (coupled with the RC controller) may be scaled to have remote plugin access where the user may actually be off-sight, and link into the track at a controlled facility not open to the general public or another gameplay arena at a normal facility filling an empty players position. This may allow the users at home pods to link into the gameplay arena and join a session against other players, similar to online first-person shooter games today.

Further, the conveyor system may facilitate continuous gameplay without the downtimes traditionally associated with RC drone gaming. Further, the conveyor system may include one or more zones. Further, certain game types may integrate two or more zones together or separate them further or have entirely new zones for a specific game type. For instance, a submersible game may include a drain zone to eliminate the water around the RC underwater drone for service in a safe manner. However, the drain zone may not be necessary in some other game types. Further, ordering of the one or more zones may vary based on the game type. Further, the conveyor system may include a track that may control the movement of the RC drone as the RC drone goes through, similar to a roller coaster, manufacturing line, or train on rails associated with the conveyor system. Further, the track and the hold type on the RC drone(s) may vary based on type and arena setup. In an instance, the track may be above the RC drone for it to hang or be along the ground. Further, at the beginning and end of the conveyor system, the conveyor system may include a set of input/output sensors for identification reading based on game type. Further, the input/output sensors may include tools like radio frequency identification (RFID), Bluetooth, barcode, QR code, WIFI, or other similar signal transmission and identification technologies. Further, the signals may be relayed to the relay station and/or directly to the gameplay server. Further, the identification reading may facilitate changing out the RC unit/drone with another fully powered and fully operational RC drone replacement. Further, the gameplay server along with other functional areas of the system may update based on the RC Units unique identification ID, match and reprogram that specific unit into the Gameplay Arena and connect to a RC Controller and RC Controller Containment Unit for that gameplay round. Further, the one or more zones along the conveyor system may be referred to as staging areas. Further, the staging areas may include essential functions to get the RC drone prepared to reenter the Gameplay Arena. Further, the staging areas may include functions like cooling, refueling gameplay items, replacing/recharging batteries, diagnostics, sorting, automated repair, relegation for technician support, testing, storage, final prep for gameplay, approval diagnostics, etc. based on gameplay type needs.

Further, the RC unit/drone may be controlled by preprogrammed functions, artificial intelligence, machine learning, a neural network or similar programming functions mentioned before to create a consistent entry and exit condition. Further, the gameplay arena (or environment) may include a field for gameplay that may allow RC units to interact with one another and objects (both virtual and physical), actions, and movements on the field. However, RC controller(s) and RC controller containment units may be scaled to life-size, the gameplay arena may be scaled to any size to fit the space it is in or mobility requirements upon traveling for mobile setup. Further, moving elements associated with the system are a part of the gameplay arena that may depend on the gameplay type. Further, the gameplay type may include racing, battle royal, submersibles, and many other game types. Further, the racing gameplay type may include car racing, buggy racing, boat/airboat (on water surface) racing, motorcycle racing, and other vehicles (or group type drones) racing. Further, the battle royal gameplay may include tanks, battle robots, etc. Further, the submersible gameplay type may include a submarines racing or battles. In an instance, in the battle royal game type, dynamic barriers may move up and down or side to side based on predefined functions (such as timing), user/onlooker interaction, or CPU engagement. Further, moving elements (such as the dynamic barriers) may make the gameplay more exciting for participants and onlookers, such as an avalanche of rocks while racing around a Volcano erupting themed course. Further, the gameplay arena may utilize special effects type equipment and technologies to make the gameplay environment come to life. Further, the special effects type equipment and technologies/techniques may be similar to the technology used for theme park rides and movie effects. Further, the special effects type equipment and technologies may include the usage of sensors such as motion, vibration, temperature, position, cameras, timers, etc. that may improve gameplay and/or the experience. Further, the gameplay arena may include element markers. Further, the element markers may include a finish line, scoreboard, live video display of gameplay/players, or time/position markers, etc. to increase gameplay fun, competition, excitement and viewing ability. Further, these position markers may be used by the preprogrammed RC units' control for navigation purposed and feedback to the gameplay engine. Further, the gameplay arena may be integrated with the RC Controller Containment Units (Game Pods) using a display system that may allow onlookers to see the game pods and information like the gamer tags/score through displays, glass and staging around the actual field of play. Further, display system may include features like winner programming that may activate fogged glass to display the winner at the end of match play. Further, the gameplay arena may tie to the Viewer Monitoring and Access Systems in conjunction with the Gameplay Server, Relay Station, and all or some of the other gameplay systems. Further, the viewer monitoring and access systems gives the system the ability to use camera, microphones, and other inputs like voiceover to display to viewers. Further, the viewer monitoring and access systems may be onsite and offsite of the gameplay location. Further, the onsite may include a viewer headset to see from the view of players (or users) in the gameplay match, displays around the arena, and even replays/score/ranking boards that may be shown through displays. Further, the offsite monitoring may allow viewers from online platforms like Youtube™, Twitch™ or other social media sites to watch gameplay, highlights and replays. Further, the gameplay arena may be thoroughly integrated with the conveyor system as to hide it from the view of the players and onlookers that may keep the magic alive and does not let the players and onlookers see the inner mechanics as much as possible. Further, the conveyor system may be associated with offshoots to and from the gameplay arena for the RC Units to be monitored, refueled and deployed among other actions. Further, the safety is a vital aspect of the overall design of the system. Further, the safety system may be required to make sure viewers, technical staff, operators, and players are safe and minimize the risk of injury. Further, the safety system may include critical safety failsafe's and is integrated into the major functional areas of the gameplay system (or platform), such as gameplay server, RC controller containment unit, RC unit, gameplay arena. These systems could be integrated into other systems (such as the gameplay arena) and include power override shutoffs, water/flame retardant sprinkler/dispenser systems, cooling battery storage areas, temperature control fans, circuitry testing/monitoring, professional emergency wash/first aid stations and protection screening for viewers and players. Further, the safety systems may vary depending on the gameplay type and system configuration but may maintain and exceed safety standards set by location related regulations and operator/owner safety policies. Further, the safety systems may include external access points for profession technicians that may be trained in the art and safety procedures. Further, the one or more components that feature the highest risk, although still low overall, such as the RC Units, gameplay arena special effects, and batteries, may only be accessible by technicians trained in the art and safety procedures or in special circumstances under direct supervision. Further, operational staff may be provided safety training, procedural documentation on operations such as checklists, and equipment for protection such as safety glasses and protective gloves.

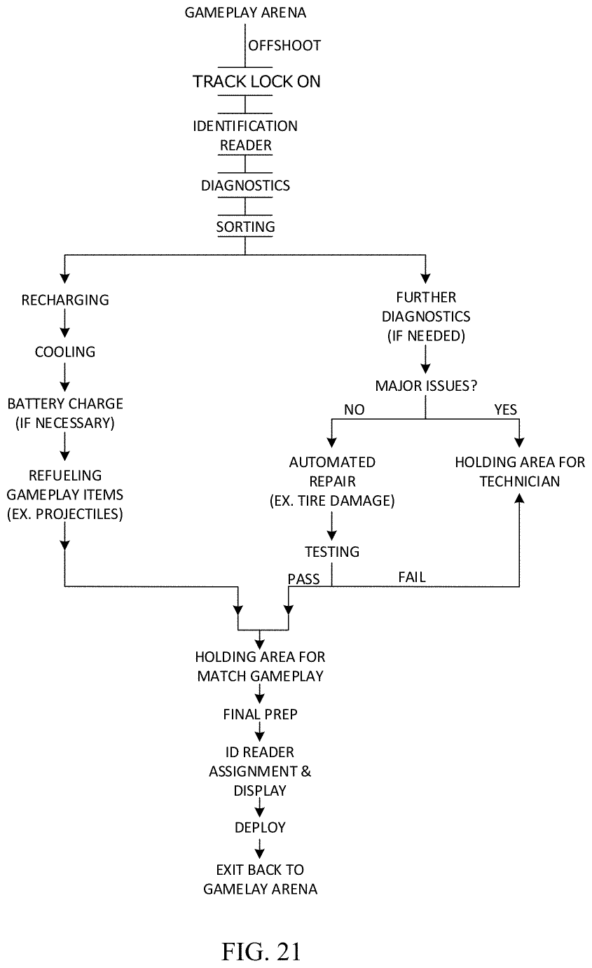

As can be seen in FIG. 21, a conveyor system process is in accordance with some embodiments. Accordingly, the process may include an RC unit that may be offshoot from a gameplay arena. Further, the process may include track lock on by the RC unit. Further, the gameplay arena may include a field for gameplay that may allow RC units interact with one another and objects. Further, the process may include identification reading. Further, during exit and reintroduction, the RC unit may be identified uniquely through the identification reader zone within the conveyor system, that may include the RFID, Bluetooth and/or other similar identification technologies. Further, the gameplay server may dynamically take the ID to reprogram and to match the radio frequency of the RC controller housed in the RC Controller Containment Unit. Further, the process may include diagnostics associated with the RC units. Further, diagnosing the RC unit may facilitate identification of defective RC units. Further, the process may include sorting of the RC units that may facilitate the separating of the RC units as good condition and defective (having issue). Further, the good RC units may be recharged and further cooled. Further, battery associated with the RC unit may be changed if necessary. Further, the automated repair of the RC units may be performed if necessary. Further, the RC units may be allowed to wait in holding area for match play reintroduction. Further, the process may include final preparation and deploying of the RC units. Further, the conveyor may include an identification reader that may uniquely identify the RC units through RFID, Bluetooth or other similar technologies. Further, the process may include deploying the RC units for the gameplay. Further, the process may include RC units to exit back to the gameplay arena. Further, upon identifying a defective RC unit with issue(s), the defective RC unit may undergo further diagnostics to identify major issues if present. Further, upon identification of the major issue, the defective RC unit may be transported to storage for service by a technician trained in the art. Further, upon identification of no major issue, the defective RC unit may undergo automated repair. Further, the process may include testing of the defective RC unit. Further, upon passing the test, the defective RC unit may be transported to the holding area for reintroduction. Further, upon failing the test again, the defective RC unit may be transported to an area for service by a technician. Further, the process may include final preparation and deploying of the RC units. Further, the conveyor may include an identification reader that may uniquely identify the RC units through RFID, Bluetooth or other similar technologies. Further, the process may include deploying the RC units for the gameplay. Further, the process may include RC units to exit back to the gameplay arena.

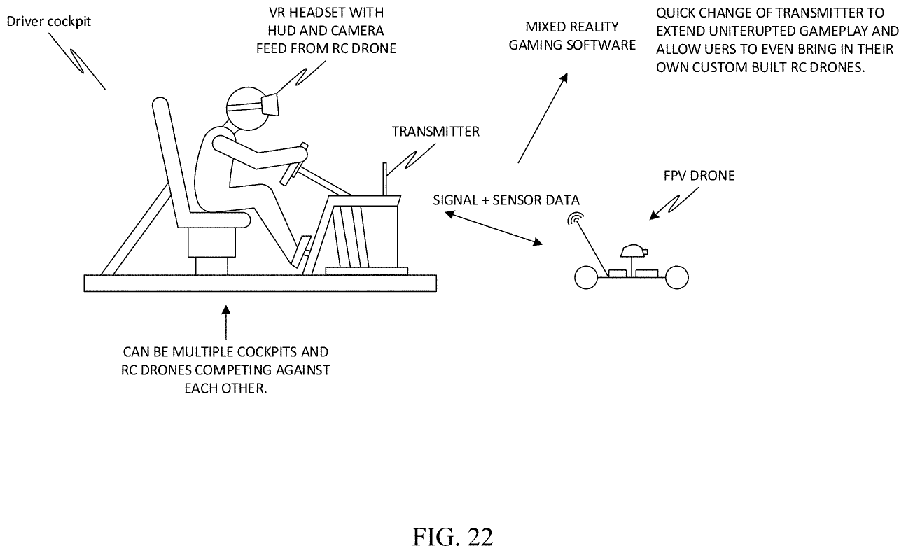

As can be seen in FIG. 22, a driver cockpit associated with the mixed reality competitive gameplay is in accordance with some embodiments. Further, the mixed reality competitive gameplay may include multiple driver cockpits and RC units competing against each other. Further, the driver cockpit may include enough space to accommodate a driver that may operate the RC unit throughout a track or course to compete against others. Further, the driver cockpit may include a transmitter. Further, the transmitter may receive and transmit sensor data from a First-Person View unit/drone. Further, the mixed reality gameplay software associated with the mixed reality competitive gameplay may facilitate quick changes of transmitter to extend uninterrupted gameplay and allow the users to even bring in custom-built RC drones/units. Further, the mixed reality gameplay software may connect the RC units to the various user control devices/environments. Further, the mixed reality gameplay software may monitor user success, allow for quick change in hardware/devices for continual gameplay, including rules for play affecting the operation of the remotely-controllable drones. Further, the mixed reality gameplay software may utilize Artificial Intelligence (AI) and other technologies similar (discussed previously) driven controls to make the RC units go back to the reset point for the gameplay start, participating in gameplay when the driver cockpit is not occupied or for switching the RC units upon reaching a higher temperature or low battery range. Further, the driver may utilize virtual reality headset technology to see from the perspective of the RC unit and use other controls built within their immediate reach to control the functions/movement of the remote-controlled vehicle. Further, the VR headset may include a heads-up display (HUD) that may be used to display camera feed from the RC unit and other gameplay pertinent information, even simple tutorials.

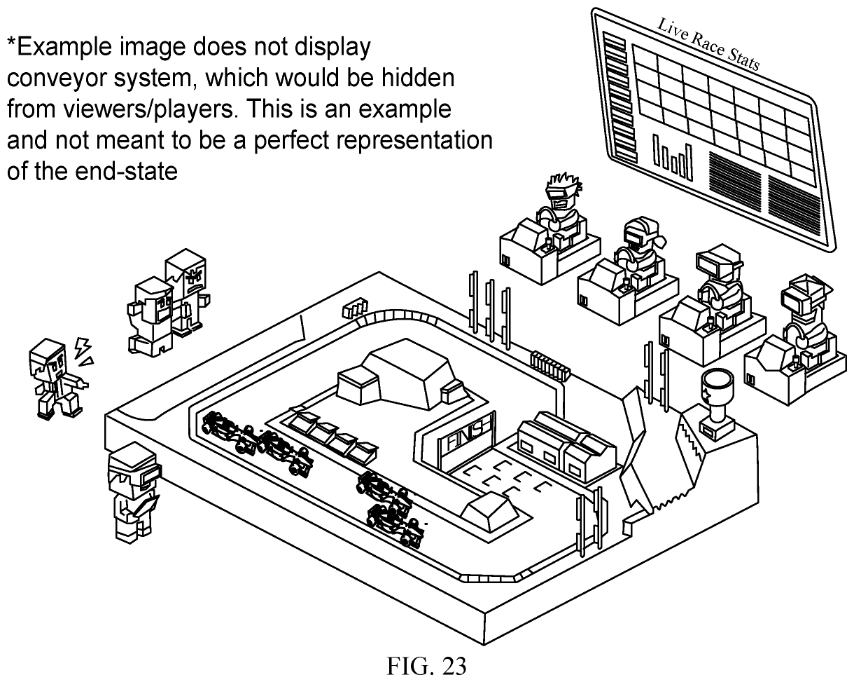

As can be seen in FIG. 23, a mixed reality competitive gameplay is in accordance with some embodiments. Accordingly, the mixed reality competitive gameplay may include a user that may operate the RC unit upon sitting in the RC controller containment unit. Further, the mixed reality competitive gameplay may include a gameplay arena. Further, the gameplay arena may include a track or course for the competition between the RC units. Further, the mixed reality competitive gameplay may include a plurality of onlookers/viewers that may include at least one individual that may want to view the mixed reality interactive gameplay from the First-Person View.

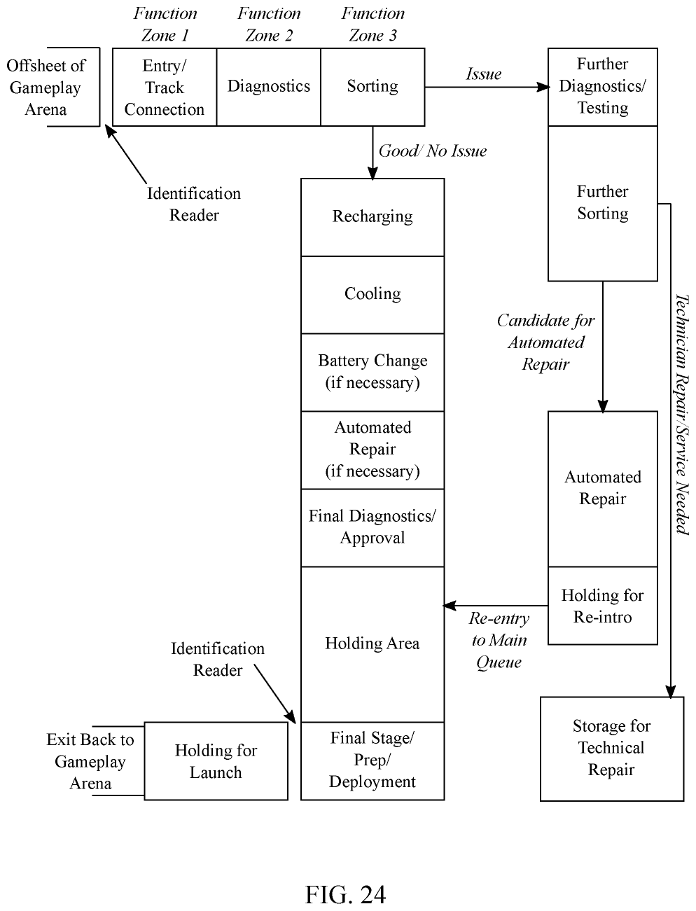

As can be seen in FIG. 24, a conveyor staging is in accordance with some embodiments. Accordingly, the conveyor staging may include offshoot from the gameplay arena. Further, the conveyor staging may include a plurality of zones. Further, the plurality of zones may include a functional zone, a functional zone, a functional zone. Further, the functional zone may include an identification reader. Further, during exit and reintroduction, the RC unit may be identified uniquely through the identification reader zone within the conveyor system, that may include the RFID, Bluetooth and/or other similar identification technologies. Further, the gameplay server may dynamically take the ID to reprogram and to match the radio frequency of the RC controller housed in the RC Controller Containment Unit. Further, the functional zone may include diagnostics associated with the RC units. Further, the functional zone may include sorting of the RC units that may facilitate the separating of the RC units as goods and defective (having issue). Further, the good RC units may be recharged and further cooled. Further, battery associated with the RC unit may be changed if necessary. Further, the automated repair of the RC units may be performed if necessary, such as tire/wheel replacement in some game types. Further, the final diagnostics associated with the RC units may be done. Further, the RC units may be allowed to wait in holding area. Further, final preparation and deploying of the RC units is done. Further, the conveyor may include an identification reader that may uniquely identify the RC units through RFID, Bluetooth or other similar technologies. Further, upon identifying a defective RC unit with issue, the defective RC unit may undergo automated repair (such as tire change). Further, the defective RC unit may be transported to storage upon identifying need for service by a technician associated with the RC unit. Further, the defective RC unit, upon automated repair, may be transported to the holding area. Further, final preparation and deploying of the RC units is done. Further, the conveyor may include an identification reader that may uniquely identify the RC units before reentry to gameplay through RFID, Bluetooth or other similar technologies.

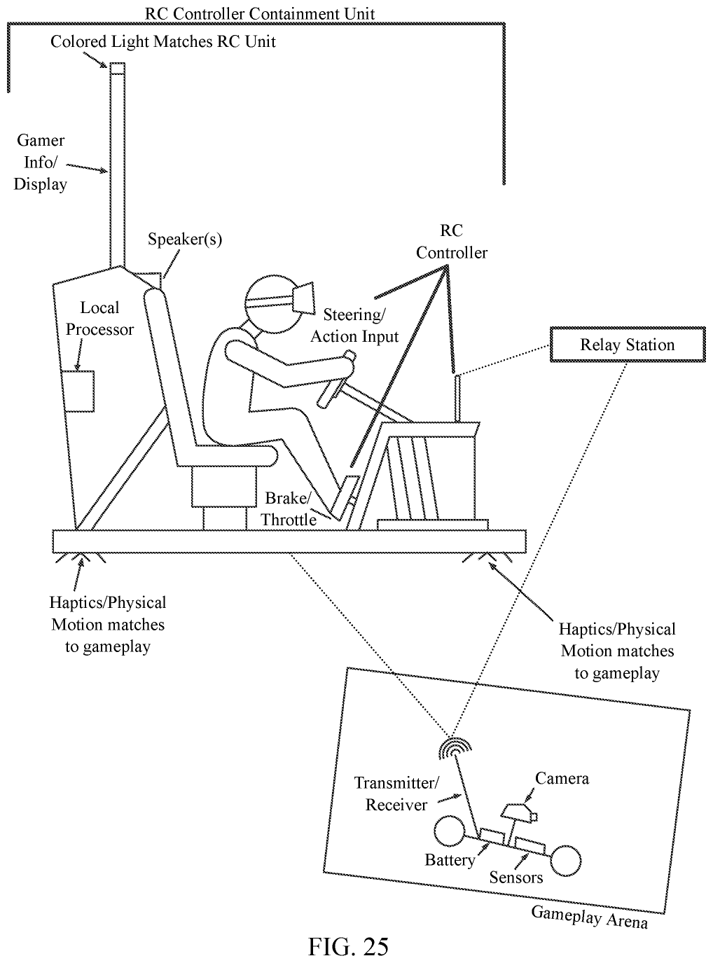

As can be seen in FIG. 25, an RC controller containment unit is in accordance with some embodiments. Accordingly, the RC controller containment unit may include RC controllers such as a steering wheel, an action button, a throttle, a brake. Further, the RC controller containment unit may include space for one or more users. Further, the RC controller containment unit may include colored light matching the RC unit, a speaker, a local processor. Further, the RC controller containment unit may provide haptics/physical movements, sensory feedback (i.e. 3D effects) and even sounds corresponding to the gameplay type to the user. Further, the RC controller containment unit may be communicatively coupled with the relay station that may be communicatively coupled with the gameplay server. Further, the RC controller containment unit may send and receive data from the RC unit in the gameplay arena. Further, the RC unit in the gameplay arena may be communicatively coupled with the relay station.

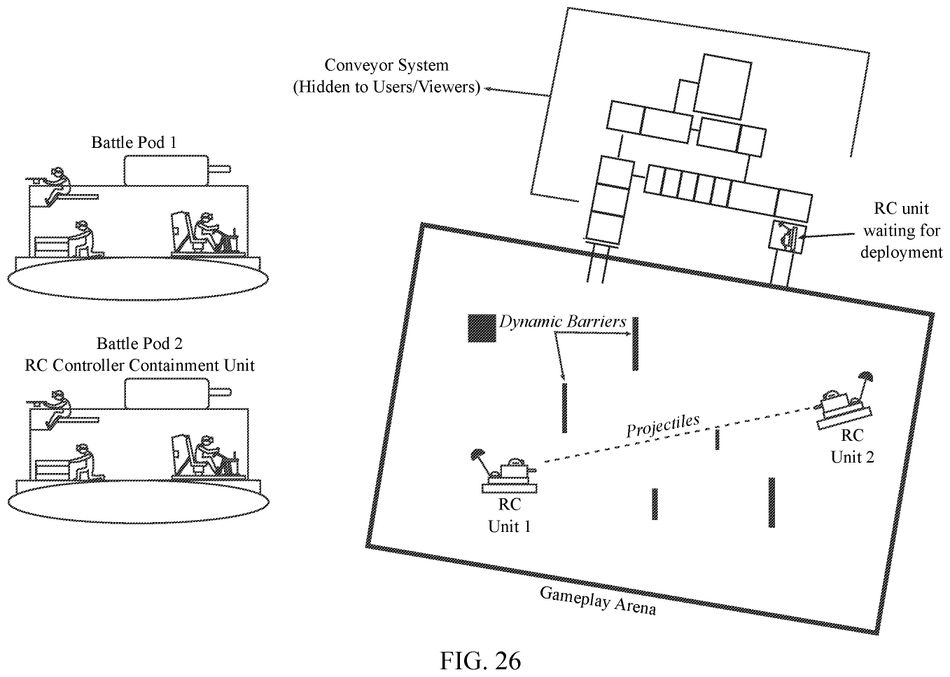

As can be seen in FIG. 26, a battle royal gameplay type is in accordance with some embodiments. Accordingly, the battle royal gameplay type may include plurality of RC controller containment units (such as battle pods, tanks, robots). Further, the plurality of battle pods may include a battle pod, a battle pod. Further, the plurality of battle pods may be configured to fire projectiles from it's corresponding RC unit at the other battle pods controlled RC unit. Further, the battle pod may include a user that may operate the battle pod. Further, a single battle pod may include one or more users controlling different aspects of the battle pod. Further, the one or more users may include a first user, a second user, a third user or more/less dependent on gameplay type. Further, the illustration shows an example configuration where the first user may control the main shooter, the second user may drive, and the third user may lookout/gunner on top of the tank. Further, the battle royal may include a conveyor system that may be hidden to the user/viewers. These battle pods may also include VR/MR/AR goggle(s) and other controls to allow user(s) to see from the perspective of the RC Unit in the gameplay arena. Further, the conveyor system may include an entrance and backup RC units that may be deployed in next round of the gameplay. Further, the battle royal gameplay may include a plurality of dynamic barriers.

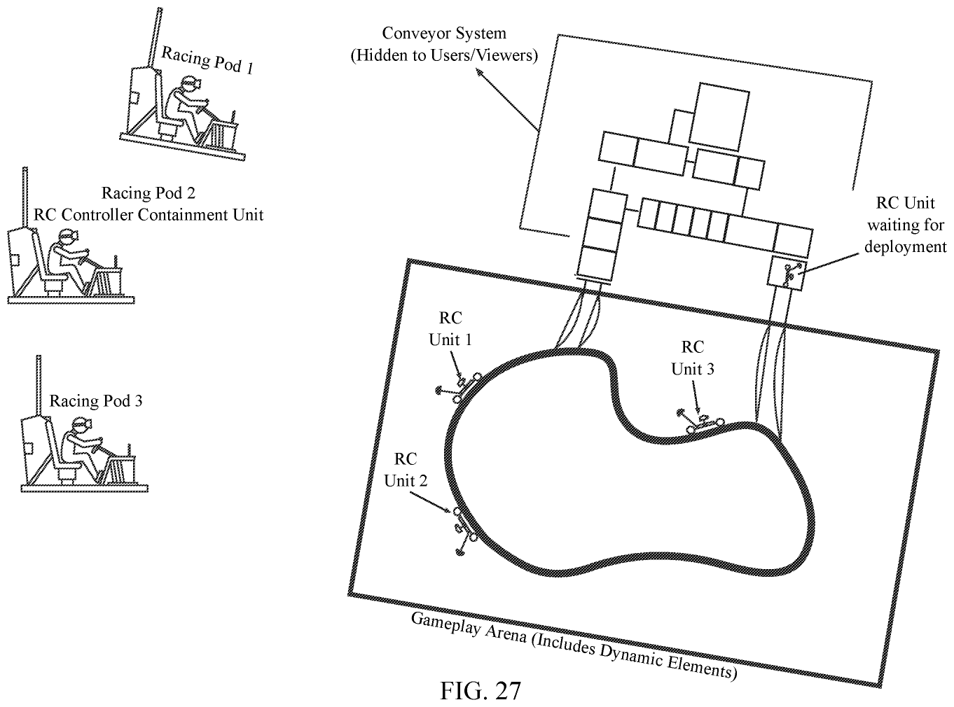

As can be seen in FIG. 27, a racing gameplay type is in accordance with some embodiments. Accordingly, the racing gameplay type may include a plurality of racing pods (such as cars, motorcycles, buggy, etc.). Further, the racing gameplay type may include a car racing, a buggy racing, a boat/airboat (on water surface) racing, motorcycle racing, and other vehicles (or group type drones) racing. Further, the racing gameplay type may include plurality of users competing against other users on a track/course in the gameplay arena. Further, the gaming arena may include dynamic elements. Further, the racing gameplay type may include the conveyor system that may be hidden to the user/viewers. Further, the conveyor system may include storage for repair and service.

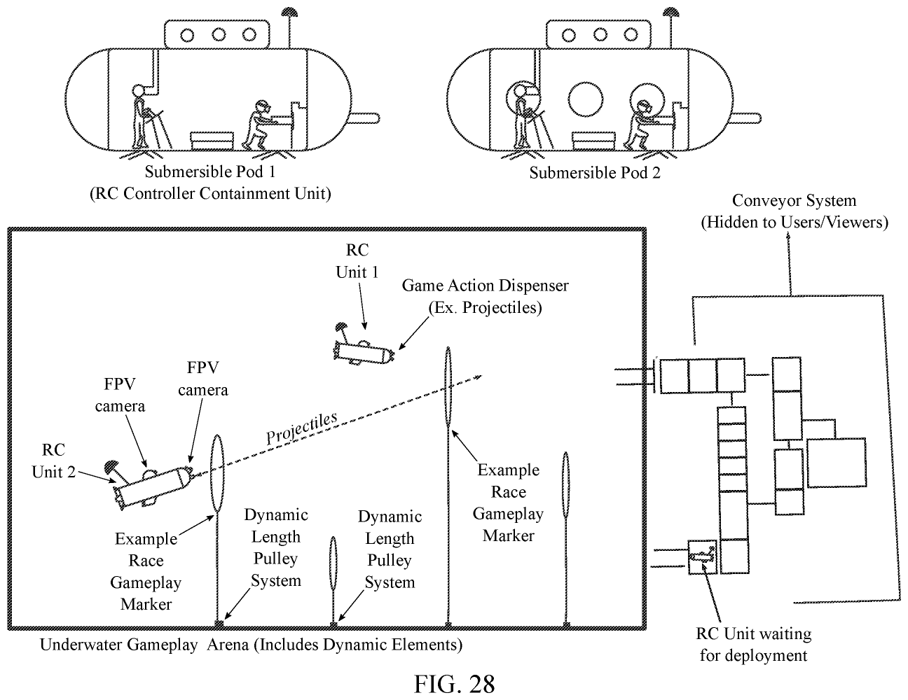

As can be seen in FIG. 28, a submersible gameplay type is in accordance with some embodiments. Accordingly, the submersible gameplay type may include a plurality of RC controller containment units (such as submersible pods). Further, the submersible pods may include one or more users. Further, the submersible pods may include a camera and game action controls/objects such as projectile that may be fired at other submersible pod-controlled RC Units in the gameplay arena. Further, a user may load game items for realistic representation of the RC units firing or other actions. Further, the submersible gameplay type may include an underwater gameplay arena. Further, the underwater gameplay arena may include one or multiple gameplay race marker(s). Further, the underwater gameplay arena may include a dynamic length pulley system or other moving elements to increase gameplay fun, challenge, and magic. Further, the dynamic length pulley system may be associated with the gameplay race example. Further, the submersible gameplay type may include the conveyor system that may be hidden to the user/viewers. A system consistent with an embodiment of the disclosure may include a computing device or cloud service.

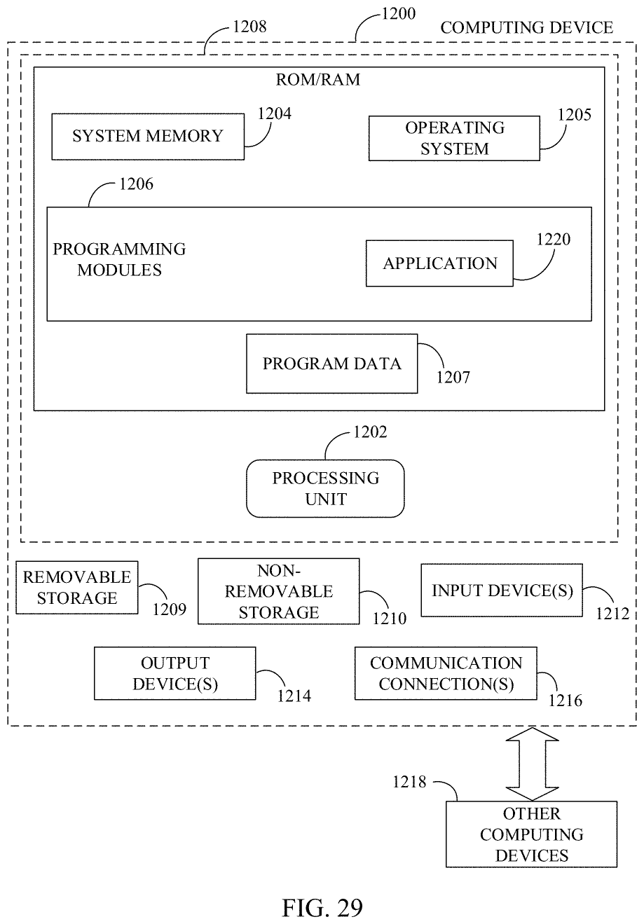

As can be seen in FIG. 29, in a basic configuration, a computing device 1200 may include at least one processing unit 1202 and a system memory 1204. Depending on the configuration and type of computing device, system memory 1204 may comprise, but is not limited to, volatile (e.g. random-access memory (RAM)), non-volatile (e.g. read-only memory (ROM)), flash memory, or any combination. System memory 1204 may include operating system 1205, one or more programming modules 1206, and may include a program data 1207. The operating system 1205, for example, may be suitable for controlling computing device's operation. In one embodiment, programming modules 1206 may include image-processing module, machine learning module and/or image classifying module. Furthermore, embodiments of the disclosure may be practiced in conjunction with a graphics library, other operating systems, or any other application program and is not limited to any particular application or system. This basic configuration is illustrated in FIG. 11 by those components within a dashed line 1208.

The computing device 1200 may have additional features or functionality. For example, computing device 1200 may also include additional data storage devices (removable and/or non-removable) such as, for example, magnetic disks, optical disks, memory discs, SD cards or tape. Such additional storage may be a removable storage 1209 and a non-removable storage 1210. Computer storage media may include volatile and nonvolatile, removable and non-removable media implemented in any method or technology for storage of information, such as computer-readable instructions, data structures, program modules, or other data. System memory 1204, removable storage 1209, and non-removable storage 1210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1200. Any such computer storage media may be part of the device 1200. The computing device 1200 may also have input device(s) 1212 such as a keyboard, a mouse, a pen, a sound input device, a touch input device, a location sensor, a camera, a biometric sensor, etc. Output device(s) 1214 such as a display, speakers, a printer, etc. may also be included. The aforementioned devices are examples and others may be used.

The computing device 1200 may also contain a communication connection 1216 that may allow device 1200 to communicate with other computing devices, such as over a network in a distributed computing environment, for example, an intranet or the Internet. Communication connection 1216 is one example of communication media.

Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in the system memory 1204, including the operating system 1205. While executing on the processing unit 1202, programming modules 1206 (e.g., application 1220 such as a media player) may perform processes including, for example, one or more stages of methods, algorithms, systems, applications, servers, databases as described above. The aforementioned process is an example, and processing unit 1202 may perform other processes. Generally, consistent with embodiments of the disclosure, program modules may include routines, programs, components, data structures, and other types of structures that may perform particular tasks or that may implement particular abstract data types.

Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention.

What is claimed is:

1. A method of competitively gaming in a mixed reality with multiple players, the method comprising the steps of:
(A) providing a plurality of player profiles managed by at least one central computing device, wherein a plurality of control pods is communicably coupled to the central computing device, and wherein each player profile is associated with a corresponding pod from the plurality of control pods;
(B) providing a plurality of automated avatars positioned within a computerized arena, wherein the automated avatars and the computerized arena are communicably coupled to the central computing device, and wherein each of the player profiles is associated with a corresponding automated avatar from the plurality of automated avatars;
(C) initializing a gameplay amongst the player profiles with the central computing device;
(D) continuously capturing real-time environment data with each automated avatar during the gameplay;
(E) continuously outputting the real-time environment data of the corresponding automated avatar for each player profile with the corresponding pod during the gameplay;
(F) prompting each player profile to enter at least one avatar instruction with the corresponding pod during the gameplay;
(G) executing the avatar instruction of at least one arbitrary profile with the corresponding automated avatar during the gameplay, if the avatar instruction is entered by the arbitrary profile, wherein the arbitrary profile is any profile from the plurality of player profiles; and
(H) executing a plurality of iterations for steps (F) through (G), until at least one winner profile is designated by the central computing device, wherein the winner profile is from the plurality of player profiles.

2. The method of competitively gaming in a mixed reality with multiple players, the method as claimed in claim 1 comprising the steps of:
providing at least one camera for each automated avatar;
providing at least one display for each control pod;
capturing video data as a portion of the real-time environment data with the camera of each automated avatar during step (C); and
outputting the video data with the display of each control pod during step (D).

3. The method of competitively gaming in a mixed reality with multiple players, the method as claimed in claim 2 comprising the steps of:
generating at least one piece of video augmentation in accordance to the gameplay with the central computing device; and
integrating the piece of video augmentation into the video data with the central computing device before step (D).

4. The method of competitively gaming in a mixed reality with multiple players, the method as claimed in claim 1 comprising the steps of:
providing at least one microphone for each automated avatar;
providing at least one speaker for each control pod;
capturing audio data as a portion of the real-time environment data with the microphone of each automated avatar during step (C); and
outputting the audio data with the speaker of each control pod during step (D).

5. The method of competitively gaming in a mixed reality with multiple players, the method as claimed in claim 4 comprising the steps of:
generating at least one piece of audio augmentation in accordance to the gameplay with the central computing device; and
integrating the piece of audio augmentation into the audio data with the central computing device before step (D).

6. The method of competitively gaming in a mixed reality with multiple players, the method as claimed in claim 1 comprising the steps of:
providing at least one inertia measurement unit (IMU) with each automated avatar;
providing at least one vibrator for each control pod;
capturing haptic data as a part of the real-time environment data with the IMU of each automated avatar during step (C); and
outputting the haptic data with the vibrator of each control pod during step (D).

7. The method of competitively gaming in a mixed reality with multiple players, the method as claimed in claim 6 comprising the steps of:
generating at least one piece of haptic augmentation in accordance to the gameplay with the central computing device; and
integrating the piece of haptic augmentation into the haptic data with the central computing device before step (D).

8. The method of competitively gaming in a mixed reality with multiple players, the method as claimed in claim 1 comprising the steps of:
providing at least one maneuver input device for each control pod, wherein the maneuver input device is configured to receive a plurality of avatar-related maneuvers;
receiving at least one desired maneuver with the maneuver input device for the corresponding pod of the arbitrary profile after step (F), wherein the desired maneuver is from the plurality of avatar-related maneuvers; and
designating the desired maneuver as the avatar instruction with the corresponding drone of the arbitrary profile.

9. The method of competitively gaming in a mixed reality with multiple players, the method as claimed in claim 1 comprising the steps of:
providing a computerized maintenance center, wherein the computerized maintenance center is positioned adjacent to the computerized arena;
transferring each automated avatar from the computerized arena to the computerized maintenance center after step (H);
assessing a preliminary diagnosis status for each automated avatar with the computerized maintenance center;
sorting a plurality of properly-functioning automated avatars out of the plurality of automated avatars with the computerized maintenance center, wherein the preliminary diagnosis status of each properly-functioning drone is indicated to have no issue;
executing a regular maintenance procedure on each properly-functioning drone with the computerized maintenance center;
sorting a plurality of improperly-functioning automated avatars out of the plurality of automated avatars with the computerized maintenance center, wherein the preliminary diagnosis status of each improperly-functioning automated avatar is indicated to have at least one issue;
executing a repair procedure on each improperly-functioning automated avatar with the computerized maintenance center; and
transferring and/or replacing each automated avatar from the computerized maintenance center to the computerized arena.

10. The method of competitively gaming in a mixed reality with multiple players, the method as claimed in claim 9 comprising the step of:
automatically maneuvering each automated avatar from the computerized arena to the computerized maintenance center by instruction from the central computing device after step (H).

11. The method of competitively gaming in a mixed reality with multiple players, the method as claimed in claim 9 comprising the steps of:
providing a plurality of alternate automated avatars, wherein the alternate automated avatars are communicably coupled to the central computing device, and wherein each player profile is associated with a corresponding alternate automated avatar from the plurality of alternate automated avatars, wherein each alternate automated avatar has already gone through either the regular maintenance procedure or the repair procedure;
immediately transferring each alternate automated avatar from the computerized maintenance center to the computerized arena, once each automated avatar is transferred from the computerized arena to the computerized maintenance center; and
executing an alternate iteration of steps (C) through (H) with the alternate automated avatars instead of the automated avatars.

12. The method of competitively gaming in a mixed reality with multiple players, the method as claimed in claim 9 comprising the steps of:
providing a portable power source for each automated avatar;
recharging the portable power source for each properly-functioning automated avatar with the computerized maintenance center during the regular maintenance procedure;
cooling each properly-functioning automated avatar with the computerized maintenance center during the regular maintenance procedure; and
replacing a worn-out part of at least one automated avatar with the computerized maintenance center during the regular maintenance procedure, if a current date-and-time lapsed an expiration date of the worn-out part, wherein the specific automated avatar is from the plurality of properly-functioning automated avatars.

13. The method of competitively gaming in a mixed reality with multiple players, the method as claimed in claim 9 comprising the steps of:
assessing a detailed diagnosis status for each automated avatar with the computerized maintenance center during the repair procedure;
sorting at least one severely-damaged drone out of the plurality of improperly-functioning automated avatars with the computerized maintenance center during the repair procedure, wherein the detailed diagnosis status of the severely-damaged automated avatar is indicated to need a technician repair service;
placing the severely-damaged automated avatar into a storage area of the computerized maintenance center for the technician repair service during the repair procedure;
sorting a plurality of mildly-damaged drones out of the plurality of improperly-functioning automated avatars with the computerized maintenance center during the repair procedure, wherein the detailed diagnosis status of each mildly-damaged automated avatar is indicated to need an automated repair service; and
executing the automated repair service on each mildly-damaged automated avatar with the computerized maintenance center during the repair procedure.

14. The method of competitively gaming in a mixed reality with multiple players, the method as claimed in claim 1 comprising the steps of:
providing at least one external personal computing (PC) device, wherein the external PC device is communicably coupled to the central computing device;
enabling remote access of at least one specific profile with the external PC device, wherein the specific profile is from the plurality of player profiles; and
enabling remote control of the corresponding pod of the specific profile with the external PC device.

15. The method of competitively gaming in a mixed reality with multiple players, the method as claimed in claim 1 comprising the step of:
enabling automated control of the corresponding pod of at least one specific profile with the central computing device, wherein the specific profile is from the plurality of player profiles.
